(19) United States
(12) Patent Application Publication
(10) Pub. No.: US 2025/0256522 A1
(43) Pub. Date: Aug. 14, 2025

(54) Recording Method And Recording Apparatus

(71) Applicant: SEIKO EPSON CORPORATION, Tokyo (JP)

(72) Inventors: Takako SUGIYAMA, Azumino (JP); Keigo ANDO, Matsumoto (JP)

(21) Appl. No.: 19/047,797

(22) Filed: Feb. 7, 2025

(30) Foreign Application Priority Data
Feb. 9, 2024 (JP) 2024-018473

(51) Int. Cl. B41M 5/00; B41J 2/21; B41J 11/00; B41M 7/00; C09D 11/322

(52) U.S. Cl. CPC B41M 5/0017; B41J 2/2114; B41J 11/002; B41M 5/0047; B41M 5/0064; B41M 7/009; C09D 11/322

(57) ABSTRACT

A recording method includes an ink adhesion step of ejecting a water-based color ink composition containing a colorant from an ink jet head so as to be adhered to a recording medium; and a clear ink adhesion step of ejecting a water-based clear ink composition from the ink jet head so as to be adhered to the recording medium, the recording medium is a non-absorbing or a low-absorbing recording medium having a surface with an in-plane surface roughness (Sa) of 0.2 μm or more, the clear ink composition contains a resin and a wax and contains no polyol having a standard boiling point of 280° C. or more functioning as an organic solvent at a content of 0.5 percent by mass or more with respect to a total mass of the clear ink composition, and the clear ink composition is adhered to a non-image portion which is a region other than an image portion which is a region of the recording medium to which the color ink composition is adhered.

The present application is based on, and claims priority from JP Application Serial Number 2024-018473, filed Feb. 9, 2024, the disclosure of which is hereby incorporated by reference herein in its entirety.

### BACKGROUND

### 1. Technical Field

The present disclosure relates to a recording method and a recording apparatus.

### 2. Related Art

Since being able to record a highly fine image using a relatively simple apparatus, an ink jet recording method has been rapidly developed in various types of fields. Among the developments, in order to improve an abrasion resistance of a recorded matter, a study in which a clear ink containing a resin is used together with a color ink has been performed.

For example, JP-A-2013-144764 has disclosed an ink jet recording method to use a clear ink composition which contains an alkanediol having 7 to 10 carbon atoms, a water-soluble alcohol functioning as a solubilizing agent to dissolve the alkanediol having 7 to 10 carbon atoms, water, and silicone-based composite resin particles and which contains no coloring agents, and by the method described above, for example, the abrasion resistance of an image to be obtained is tried to be improved.

In the case in which a recorded matter is obtained by forming an image on a non-absorbing or a low-absorbing recording medium having a high in-plane surface roughness (Sa), when this recorded matter is rubbed, a non-image portion (portion on which no image is recorded) is stained in some cases. Hence, there has been desired a recording method in which even if an image is formed on the recording medium as described above, the non-image portion of the recorded matter is unlikely to be stained.

### SUMMARY

According to an aspect of the present disclosure, there is provided a recording method comprising: an ink adhesion step of ejecting a water-based color ink composition containing a colorant from an ink jet head so as to be adhered to a recording medium; and a clear ink adhesion step of ejecting a water-based clear ink composition from the ink jet head so as to be adhered to the recording medium. In the recording method described above, the recording medium is a non-absorbing or a low-absorbing recording medium having a surface with an in-plane surface roughness (Sa) of 0.2 μm or more, the clear ink composition contains a resin and a wax and contains no polyol having a standard boiling point of 280° C. or more functioning as an organic solvent at a content of 0.5 percent by mass or more with respect to a total mass of the clear ink composition, and the clear ink composition is adhered to a non-image portion which is a region other than an image portion which is a region of the recording medium to which the color ink composition is adhered.

According to another aspect of the present disclosure, there is provided a recording apparatus which performs the recording method described above, the apparatus comprising: the color ink composition; the clear ink composition; and an ink jet head to eject the color ink composition and the clear ink composition.

### BRIEF DESCRIPTION OF THE DRAWINGS

FIG. 1 is a schematic cross-sectional view showing an ink jet recording apparatus.

FIG. 2 is a perspective view showing one example of the structure in the vicinity of a carriage of the ink jet recording apparatus.

FIG. 3 is a schematic view showing one example of the arrangement of ink jet heads.

FIG. 4 is a schematic view showing one example of the arrangement of ink jet heads.

FIG. 5 is Table 1 showing compositions used in Examples and Comparative Examples.

FIG. 6 is Table 2 showing compositions used in Examples and Comparative Examples.

FIG. 7 is Table 3 showing evaluation conditions and evaluation results of Examples.

FIG. 8 is Table 4 showing evaluation conditions and evaluation results of Examples.

FIG. 9 is Table 5 showing evaluation conditions and evaluation results of Examples, Comparative Examples, and Reference Example.

### DESCRIPTION OF EMBODIMENTS

Hereinafter, embodiments of the present disclosure will be described. The following embodiments are to explain examples of the present disclosure. The present disclosure is not limited at all to the following embodiments and may be variously changed and/or modified without departing from the scope of the present disclosure. In addition, all the structures which will be described below are not always required to be essential structures of the present disclosure.

### 1. Recording Method

A recording method according to this embodiment includes an ink adhesion step of ejecting a water-based color ink composition containing a colorant from an ink jet head so as to be adhered to a recording medium and a clear ink adhesion step of ejecting a water-based clear ink composition from the ink jet head so as to be adhered to the recording medium.

A non-absorbing or a low-absorbing recording medium, such as synthetic paper including a plastic as a substrate, has a paper-like texture, a water resistance, and a property not easily broken. However, when an image is formed on the synthetic paper as described above to obtain a recorded matter, and when this recorded matter is rubbed, a non-image portion (portion on which no image is recorded) may be stained in some cases. As one reason for this stain, it is assumed that an ink in an image portion is peeled away and then transferred to the non-image portion.

In particular, in the case in which, for example, printing is continuously performed many times, and/or recorded matters are handled, when the non-image portion of the recording medium is brought into contact with the image portion, and the image portion is rubbed with the non-image portion of the recording medium, the phenomenon described above is liable to occur. Since surface irregularity is formed in the synthetic paper described above, it is believed that when the image portion is rubbed with the non-image portion, the ink of the image portion is peeled away and transferred to the non-image portion, and as a result, the non-image portion of the recorded matter is stained. Hence, there has been desired a recording method in which even when an image is formed on a non-absorbing or a low-absorbing recording medium including a substrate with a high in-plane surface roughness (Sa), the non-image portion of the recorded matter is unlikely to be stained.

### 1.1. Recording Medium

In the recording method of this embodiment, a non-absorbing or a low-absorbing recording medium including a substrate with an in-plane surface roughness (Sa) of 0.2 μm or more is used. As the recording medium as described above, among the following low-absorbing or non-absorbing recording media, a recording medium having a surface with an in-plane surface roughness (Sa) of 0.2 μm or more may be mentioned.

The low-absorbing or the non-absorbing recording medium indicates a recording medium which hardly absorbs a liquid or which absorbs no liquid at all, respectively. In a quantitative point of view, the low-absorbing or the non-absorbing recording medium indicates “a recording medium having a water absorption amount of 10 mL/m² or less from a contact start to 30 m seconds^{1/2} measured by Bristow method”. This Bristow method is the most popular measurement method of a liquid absorption amount in a short time and has also been employed by Japan Technical Association of the Pulp and Paper Industry (JAPAN TAPPI). The details of the test method have been disclosed in Standard No. 51 “Paper and Paperboard-Liquid Absorption Test Method-Bristow Method”, JAPAN TAPPI PAPER AND PULP TEST METHODS, 2000. In addition, on the other hand, an absorbing recording medium indicates a recording medium corresponding to neither the low-absorbing recording medium nor the no-absorbing recording medium.

As the low-absorbing recording medium, for example, a recording medium in which a low-absorbing coating layer is provided on a substrate surface may be mentioned, and the above recording medium is called coating paper. For example, as coating paper having a substrate made of paper, printing paper, such as art paper, coated paper, or mat paper, may be mentioned, and as coating paper having a substrate made of a plastic film, for example, there may be mentioned paper in which a plastic surface formed, for example, from a poly(vinyl chloride), a poly(ethylene terephthalate), a polycarbonate, a polystyrene, a polyurethane, a polyethylene, or a polypropylene is coated, for example, with a polymer or is coated with particles of silica, titanium, or the like together with a binder.

As the non-absorbing recording medium, for example, a medium in which a plastic is coated on a substrate formed of paper or the like, a medium in which a plastic film is adhered to a substrate formed of paper or the like, or a plastic film having no absorbing layer (receiving layer) may be mentioned. As the plastic in this case, for example, there may be mentioned a poly(vinyl chloride), a poly(ethylene terephthalate), a polycarbonate, a polystyrene, a polyurethane, a polyethylene, or a polypropylene.

Among those mentioned above, a recording medium using a polyolefin-based film substrate is more preferable. The “polyolefin-based” resin is a generic name of a polymer formed using an alkene (olefin) as a monomer. For example, a polyethylene or a polypropylene may be mentioned.

The “in-plane surface roughness (Sa)” indicates the average of absolute values of differences (z(x,y)) in height at measurement points from an average surface in a reference area A and is represented by the following equation. The details of the “in-plane surface roughness Sa” are defined in ISO 25178. The “in-plane surface roughness (Sa)” is also called the “arithmetic mean height Sa” in some cases.

Sa=(1/A)∫∫_{A}|z(x,y)|dₓd_{y}

The surface roughness Sa can be measured, for example, by a method in accordance with ISO 25178 using a laser microscope (VK-X1000/manufactured by Keyence Corporation).

Although the surface roughness Sa of the surface of the recording medium to which the ink is adhered is 0.2 μm or more, since the effect of the recording method of this embodiment can be made more significant, the surface roughness Sa described above is preferably 0.3 μm or more, more preferably 0.4 μm or more, further preferably 0.5 μm or more, and particularly preferably 0.6 μm or more. Although being not particularly limited, an upper limit of the surface roughness Sa is preferably 1.5 μm or less, more preferably 1.0 μm or less, and further preferably 0.8 μm or less.

The recording medium may contain inorganic particles in a substrate surface. As the inorganic particles, for example, an inorganic oxide, such as silica including colloidal silica, titanium dioxide, aluminium oxide (alumina), zinc oxide, antimony oxide, magnesium oxide, or zirconium oxide; an inorganic carbonate salt, such as calcium carbonate; or an inorganic sulfate salt, such as calcium sulfate, may be preferably used, and a mixture thereof may also be used.

The shape of the inorganic particle is not particularly limited, and for example, a spherical shape, a bar shape, a prayer beads shape formed of beads connected to each other, or a needle shape may be used. Among those mentioned above, a spherical shape or a bar shape is preferable, and a spherical shape is particularly preferable.

In addition, the shape of the inorganic particle can be confirmed by observation using a scanning electron microscope. The “spherical shape” in the present disclosure approximately indicates, when observation is performed using a scanning electron microscope, the shape other than a prayer beads shape formed of primary particles connected to each other, a bar shape, a needle shape, and the like and is not limited to a true sphere and an oval sphere.

### 1.2. Ink Adhesion Step

In the ink adhesion step, a water-based color ink composition containing a colorant is ejected from an ink jet head and is adhered to a recording medium.

### 1.2.1. Color Ink Composition

The color ink composition is a water-based ink composition containing a colorant.

### 1.2.1. (1) Colorant

As the colorant, for example, a pigment and a dye may be mentioned.

### Pigment

As the pigment, for example, inorganic pigments, such as carbon black and titanium white, and organic pigments may be used.

As the inorganic pigment, a carbon black (C.I. Pigment Black 7), such as a furnace black, a lamp black, an acetylene black, or a channel black, iron oxide, titanium oxide, zinc oxide, or silica may be used.

As the carbon black, for example, there may be mentioned No. 2300, 900, MCF88, No. 20B, No. 33, No. 40, No. 45, No. 52, MA7, MA8, MA100, or No2200B (manufactured by Mitsubishi Chemical Co., Ltd.). Carbon Black FW1, FW2, FW2V, FW18, FW200, S150, S160, S170, Pretex 35, U, V, 140U, Special Black 6, 5, 4A, 4, or 250 (manufactured by Degussa) may be mentioned by way of example. Conductex SC, Raven 1255, 5750, 5250, 5000, 3500, 1255, or 700 (manufactured by Columbia Carbon Inc.) may be mentioned by way of example. In addition, Regal 400R, 330R, 660R, Mogul L, Monarch 700, 800, 880, 900, 1000, 1100, 1300, 1400, or Elftex 12 (manufactured by Cabot Corporation) may be mentioned by way of example.

As the organic pigment, for example, there may be mentioned by way of example, a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, or an azo-based pigment.

The colorant of the color ink composition is preferably a quinacridone-based pigment. While being excellent in color development property and weather resistance, the quinacridone-based pigment is liable to be re-dispersed by a water component. Hence, when a color ink composition containing a quinacridone-based pigment is used, the wet abrasion resistance may be inferior in some cases. On the other hand, according to the ink set of this embodiment, even when a color ink composition containing a quinacridone-based pigment is used, a preferable wet abrasion resistance tends to be obtained.

As the quinacridone-based pigment, for example, there may be mentioned C.I. Pigment Red 122, 209, or 202, C.I. Pigment Violet 19, or C.I. Pigment Orange 48 or 49.

As a concrete example of the organic pigment used for the color ink composition, the following may be mentioned.

As a cyan pigment, for example, C.I. Pigment Blue 1, 2, 3, 15:3, 15:4, 15:34, 16, 22, or 60: or C.I. Vat Blue 4 or 60 may be mentioned, and preferably, for example, one selected from the group consisting of C.I. Pigment Blue 15:3, 15:4, and 60 may be used alone, or at least two types thereof may be used in combination as a mixture.

As a magenta pigment, for example, C.I. Pigment Red 5, 7, 12, 48 (Ca), 48 (Mn), 57(Ca), 57:1, 112, 122, 123, 168, 184, 202, or 209; or C.I. Pigment violet 19 may be mentioned, and preferably, for example, one selected from the group consisting of C.I. Pigment Red 122, 202, and 209; and C.I. Pigment Violet 19 may be used alone, or at least two types thereof may be used in combination as a mixture. The pigments mentioned above each may also be in the form of solid solution.

As a yellow pigment, for example, C.I. Pigment Yellow 1, 2, 3, 12, 13, 14C, 16, 17, 73, 74, 75, 83, 93, 95, 97, 98, 109, 110, 114, 128, 129, 138, 150, 151, 154, 155, 180, or 185 may be mentioned, and preferably, for example, one selected from the group consisting of C.I. Pigment Yellow 74, 109, 110, 128, 138, 155, and 180 may be used alone, or at least two types thereof may be used in combination as a mixture.

As an orange pigment, C.I. Pigment Orange 36, 43, or a mixture thereof may be mentioned by way of example. As a green pigment, C.I. Pigment Green 7, 36, or a mixture thereof may be mentioned by way of example.

In addition, a photoluminescent pigment may also be used, and although any substance may be used as long as having photoluminescence when adhered to a medium, for example, there may be mentioned metal particles (also called a metal pigment) of a metal selected from the group consisting of aluminum, silver, gold, platinum, nickel, chromium, tin, zinc, indium, titanium, and copper or of an alloy containing at least two metals thereof, or a pearl pigment having pearl gloss. As a typical example of the pearl pigment, for example, a pigment having pearl gloss or interferential gloss, such as titanium dioxide coated mica, fish scale flakes, or bismuth acid chloride, may be mentioned. In addition, in order to suppress a reaction with water, the photoluminescent pigment may be processed by a surface treatment.

In addition, a white pigment may also be used, and for example, a metal compound, such as a metal oxide, barium sulfate, or calcium carbonate, may be mentioned. As the metal oxide, for example, titanium dioxide, zinc oxide, silica, alumina, or magnesium oxide may be mentioned. In addition, as the white pigment, particles having a hollow structure may also be used.

The pigments mentioned above may be used alone, or at least two types thereof may be used in combination. In view of storage stability, such as light resistance, weather resistance, and gas resistance, the pigment is preferably an organic pigment.

A volume average particle diameter (D50) of the pigment measured by a dynamic light scattering method is 20 to 300 nm, preferably 30 to 200 nm, and more preferably 40 to 100 nm.

The measurement of the volume average particle diameter may be performed using a particle size distribution measurement apparatus of the Nanotrac Series (manufactured by MicrotracBel Corp.). In addition, as a method to adjust the volume average particle diameter, for example, there may be mentioned a method to adjust the degree of pulverization of the pigment before it is dispersed, a method to adjust stirring conditions (such as a stirring speed and a stirring temperature) when the pigment is dispersed, or an adjusting method by filtration using a filter after the pigment is dispersed.

The pigment may be dispersed using a pigment dispersant. In addition, the pigment may be dispersed as a self-dispersible pigment after pigment surfaces are oxidized or sulfonated using ozone, hypochlorous acid, fuming sulfuric acid, or the like.

The pigment dispersant has a function to disperse a pigment in a color ink composition. Although the pigment dispersant may be water soluble, a pigment dispersant not having a perfect water solubility is preferable, and the reason for this is believed such that since the dispersant is partially or totally adsorbed or bonded to the pigment so as to enhance a hydrophilic property of the surface of the pigment, the pigment can be dispersed. The pigment dispersant is preferably a high molecular weight compound and is more preferably a resin. In addition, a pigment dispersed by a pigment dispersant which is a resin is also called, in particular, a resin dispersion pigment.

As the resin of the pigment dispersant, for example, there may be mentioned an acrylic-based resin, such as a poly(meth)acrylic acid, a (meth)acrylic acid-acrylonitrile copolymer, a (meth)acrylic acid-(meth)acrylate ester copolymer, a vinyl acetate-(meth)acrylate ester copolymer, a vinyl acetate-(meth)acrylic acid copolymer, a vinylnaphthalene-(meth)acrylic acid copolymer, a styrene-(meth)acrylic acid copolymer, a styrene-(meth)acrylate ester copolymer, a styrene-(meth)acrylic acid-(meth)acrylate ester copolymer, a styrene-α-methylstyrene-(meth)acrylic acid copolymer, or a styrene-α-methylstyrene-(meth)acrylic acid-(meth)acrylate ester copolymer; or a salt thereof. In addition, in this specification, a polymer which has a skeleton derived from (meth)acrylic acid and which has not a skeleton derived from maleic acid or an analog thereof is called an acrylic-based resin.

In addition, as the resin of the pigment dispersant, for example, there may be mentioned a maleic acid-based resin, such as a styrene-maleic acid copolymer, a styrene-maleic anhydride copolymer, a vinylnaphthalene-maleic acid copolymer, or a vinyl acetate-maleate ester copolymer, or a salt thereof; an urethane-based resin regardless of whether or not having a cross-linking structure or its salt; a poly(vinyl alcohol); or a vinyl acetate-crotonic acid copolymer or its salt.

In addition, besides the polymers formed of an acrylic-based monomer as described above, the acrylic-based resin may be a copolymer obtained from an acrylic-based monomer and another monomer. For example, an acrylic vinyl resin which is a copolymer using a vinyl monomer as the another monomer is also called the acrylic-based resin. In addition, for example, among the styrene-based resins mentioned above, a copolymer obtained from a styrene-based monomer and an acrylic-based monomer is also included in the acrylic-based resin. Furthermore, the acrylic-based resin of this embodiment also includes a salt and an ester compound thereof.

As a commercial product of the pigment dispersant, for example, there may be mentioned X-200, X-1, X-205, X-220, or X-228 (manufactured by Seiko PMC Corporation); Nopcosparse (registered trademark) 6100 or 6110 (manufactured by San Nopco Co., Ltd.); Joncryl 67, 586, 611, 678, 680, 682, or 819 (manufactured by BASF); DISPER BYK-190 (manufactured by BYK Japan KK): or N-EA137, N-EA157, N-EA167, N-EA177, N-EA197D, N-EA207D, or E-EN10 (manufactured by DKS Co., Ltd.).

As a commercial product of the acrylic-based pigment dispersant, for example, there may be mentioned BYK-187, BYK-190, BYK-191, BYK-194N, or BYK-199 (manufactured by BYK Japan KK); or Aron A-210, A6114, AS-1100, AS-1800, A-30SL, A-7250, or CL-2 (manufactured by Toagosei Company, Limited).

As a commercial product of the urethane-based pigment dispersant, for example, there may be mentioned BYK-182, BYK-183, BYK-184, or BYK-185 (manufactured by BYK Japan KK); TEGO Disperse 710 (manufactured by Evonic Tego Chemi); or Borchi (registered trademark) Gen 1350 (manufactured by OMG Borschers).

The pigment dispersant may be used alone, or at least two types thereof may be used in combination. A total content of the pigment dispersant with respect to 100 percent by mass of the color ink composition is 0.1 to 30 percent by mass, preferably 5 to 25 percent by mass, and more preferably 10 to 20 percent by mass. Since the content of the pigment dispersant is 0.1 percent by mass or more, a dispersion stability of the pigment can be secured. In addition, when the content of the pigment dispersant is 30 percent by mass or less, the viscosity of the color ink composition can be suppressed to be low.

In addition, the pigment dispersant more preferably has a weight average molecular weight of 500 or more. Since the pigment dispersant as described above is used, the odor is reduced, and the dispersion stability of the pigment can be made more preferable.

When the pigment is dispersed using a pigment dispersant, a ratio of the pigment to the pigment dispersant is preferably 10:1 to 1:10 and more preferably 4:1 to 1:3.

The self-dispersible pigment is a pigment which is surface modified, for example, by directly or indirectly binding to the surface, at least one functional group selected from the group consisting of a carbonyl group, a carboxy group, an aldehyde group, a hydroxy group, a sulfone group, an ammonium group, and a salt thereof.

As the self-dispersible pigment, for example, there may be mentioned an organic pigment, such as an azo lake, an insoluble azo pigment, a condensed azo pigment, a chelate azo pigment, a phthalocyanine pigment, a perylene pigment, a perinone pigment, a quinacridone pigment, a thioindigo pigment, an isoindolinone pigment, a quinophthalone pigment, a dioxazine pigment, an anthraquinone pigment, a nitro pigment, a nitroso pigment, or an aniline black; or an inorganic pigment, such as titanium white, zinc oxide, lead white, carbon black, red iron oxide, vermilion, cadmium red, chrome yellow, ultramarine blue, cobalt blue, cobalt purple, or zinc chromate.

Among those self-dispersible pigments mentioned above, the carbon black is preferable since a black color can be printed at a high density, and an ejection reliability can be made more excellent.

As the self-dispersible pigment, a preparation or a commercial product prepared by a known method may be used. As the commercial product, for example, “Microjet CW1” or “Microjet CW2” manufactured by Orient Chemical Co., Ltd., or “CAB-O-JET 200” or “CAB-O-JET 300” manufactured by Cabot Corporation may be mentioned.

### Dye

The color ink composition may also use a dye as the colorant. Although the dye is not particularly limited, for example, an acidic dye, a direct dye, a reactive dye, a basic dye, and a disperse dye may be usable.

A content of the dye with respect to the total mass of the color ink composition is not particularly limited, and the content described above is preferably 0.1 to 15 percent by mass, more preferably 0.5 to 10 percent by mass, even more preferably 1 to 8 percent by mass, further preferably 1.5 to 6 percent by mass, and particularly preferably 2 to 5 percent by mass.

### 1.2.1. (2) Water

The color ink composition is a water-based composition. The “water-based” composition indicates a composition containing at least water as a solvent component and may contain water as a primary solvent component.

As the water, for example, there may be mentioned pure water, such as ion exchange water, ultrafiltration water, reverse osmosis water, or distilled water; or ultrapure water in which ionic impurities are removed as much as possible. In addition, by the use of water sterilized by UV radiation, addition of hydrogen peroxide, or the like, when the color ink composition is stored for a long time, generation of bacteria and fungi can be suppressed.

A content of the water in a liquid medium component is preferably 50 percent by mass or more, more preferably 50 to 100 percent by mass, even more preferably 70 to 100 percent by mass, further preferably 90 to 100 percent by mass, and particularly preferably 95 to 99 percent by mass. The liquid medium indicates a solvent component, such as water or an organic solvent.

In addition, a content of the water with respect to the total mass of the color ink composition is preferably 40 percent by mass or more, more preferably 50 percent by mass or more, even more preferably 60 percent by mass or more, further preferably 70 percent by mass or more, and particularly preferably 80 percent by mass or more. Although being not particularly limited, an upper limit of the content of the water with respect to the total mass of the color ink composition is preferably, for example, 99 percent by mass or less and more preferably 95 percent by mass or less.

### 1.2.1. (3) Other Components

### Organic Solvent

The color ink composition may also contain an organic solvent. As the organic solvent, for example, an ester, an alkylene glycol ether, a cyclic ester, an amide, an alcohol, or a polyvalent alcohol may be mentioned. Among those mentioned above, a water-soluble organic solvent is more preferable.

As the ester, for example, there may be mentioned a glycol monoacetate, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, or methoxybutyl acetate; or a glycol diester, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, or dipropylene glycol acetate propionate.

As the alkylene glycol ether, for example, a monoether or a diether of an alkylene glycol may be used, and an alkyl ether is preferable. As a concrete example, for example, there may be mentioned an alkylene glycol monoalkyl ether, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, or tripropylene glycol monobutyl ether; or an alkylene glycol dialkyl ether, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methylethyl ether, diethylene glycol methylbutyl ether, triethylene glycol dimethyl ether, triethylene glycol diethyl ether, triethylene glycol dibutyl ether, triethylene glycol methylbutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, or tripropylene glycol dimethyl ether.

As the cyclic ester, for example, there may be mentioned a cyclic ester (lactone), such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, or ε-decanolactone; or a compound in which a hydrogen atom of a methylene group adjacent to the carbonyl group thereof is replaced by an alkyl group having 1 to 4 carbon atoms.

As the amide, for example, a cyclic amide or an acyclic amide may be mentioned. As the acyclic amide, for example, an alkoxyalkylamide may be mentioned.

As the cyclic amide, for example, a lactam may be mentioned. As the lactam, for example, a pyrrolidone, such as 2-pyrrolidone, 1-methyl-2-pyrrolidone, 1-ethyl-2-pyrrolidone, 1-propyl-2-pyrrolidone, or 1-butyl-2-pyrrolidone, may be mentioned.

As the alkoxyalkylamide, for example, there may be mentioned 3-methoxy-N,N-dimethylpropionamide, 3-methoxy-N,N-diethylpropionamide, 3-methoxy-N,N-methyethyllpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, or N,N-dimethylisobutyramide.

As the alcohol, for example, a compound in which one hydrogen atom of an alkane is replaced by a hydroxy group may be mentioned. As the alkane, an alkane having 10 carbon atoms or less is preferable, an alkane having 6 carbon atoms or less is more preferable, and an alkane having 3 carbon atoms or less is further preferable. The number of carbon atoms of the alkane is one or more and is preferably 2 or more. The alkane may have either a linear structure or a branched structure. As the alcohol, for example, there may be mentioned methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxyethanol, benzyl alcohol, or phenoxypropanol.

The polyol is a compound having at least two hydroxy groups in its molecule. The polyol is also called a polyvalent alcohol. As the polyol, for example, an alkanediol or a polyol other than that may be mentioned.

As the alkanediol, for example, a compound in which hydrogen atoms of an alkane are replaced by two hydroxy groups may be mentioned. As the alkanediol, for example, a 1,2-alkanediol which is a generic name of a compound in which hydrogen atoms of an alkane located at the positions 1 and 2 are replaced by hydroxy groups or an alkanediol other than the 1,2-alkanediol may be mentioned.

As the 1,2-alkanediol, for example, there may be mentioned ethylene glycol, 1,2-propanediol (propylene glycol), 1,2-butanediol (1,2BD), 1,2-penetanediol (1,2PD), 1,2-hexanediol (1,2HD), 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, or 3-ethyl-4-methyl-1,2-hexanediol.

As the other alkanediols, for example, there may be mentioned 1,3-propanediol, 1,3-butylene glycol (alias: 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 2-methylpentane-2,4-diol, 1,6-hexanediol, 2-ethyl-2-methyl-1,3-propanediol, and 2-methyl-2-propyl-1,3-propanediol. Among the alkanediols, an alkanediol having 5 carbon atoms or more is preferable, and an alkanediol having 5 to 10 carbon atoms is more preferable.

As the other polyol, for example, an intermolecular condensate in which at least two alkanediol molecules are condensed between hydroxy groups or a compound having at least three hydroxy groups may be mentioned. In addition, as the other polyol, a compound other than an alkanediol having 5 carbon atoms or more may be mentioned. That is, for example, an alkanediol having 4 carbon atoms or less, an intermolecular condensate in which at least two alkanediol molecules are condensed between hydroxy groups, or a compound having at least three hydroxy groups may be mentioned.

As the intermolecular condensate in which at least two alkanediol molecules are condensed between hydroxy groups, for example, a dialkylene glycol, such as diethylene glycol or dipropylene glycol, or a trialkylene glycol, such as triethylene glycol or tripropylene glycol, may be mentioned.

The compound having at least three hydroxy groups is a compound having an alkane or a polyether structure as its skeleton and at least three hydroxy groups. As the compound having at least three hydroxy groups, for example, there may be mentioned glycerin, trimethylolethane, trimethylolpropane, 1,2,5-hexanetriol, 1,2,6-hexanetriol, pentaerythritol, or a poly(oxypropylene)triol.

The organic solvent may be used alone, or at least two types thereof may be used in combination.

When the color ink composition contains an organic solvent, a content thereof with respect to the total mass of the color ink composition is preferably 1 percent by mass or more in total, more preferably 1 to 40 percent by mass, even more preferably 3 to 30 percent by mass, further preferably 5 to 25 percent by mass, and particularly preferably 7 to 20 percent by mass.

In addition, a content of the polyvalent alcohol may be preferably set in the range described above. In addition, a content of the alkanediol may also be preferably set in the range described above. Furthermore, a content of the alkanediol having 5 carbon atoms or more with respect to the total mass of the color ink composition is preferably 0.5 percent by mass or more, more preferably 1 to 20 percent by mass, even more preferably 2 to 15 percent by mass, and further preferably 3 to 10 percent by mass.

### Surfactant

The color ink composition may also contain a surfactant. Although the surfactant is not particularly limited, for example, there may be mentioned an acetylene glycol-based surfactant, a fluorine-based surfactant, or a silicone-based surfactant.

Although the acetylene glycol-based surfactant is not particularly limited, for example, there may be mentioned Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, or DF110D (trade name, manufactured by Air Products Japan, K.K.); Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, or AE-3 (trade name, manufactured by Nissin Chemical Industry Co., Ltd.); or Acetylenol E00, E00P, E40, or E100 (trade name, manufactured by Kawaken Fine Chemicals Co., Ltd.).

As the fluorine-based surfactant, a fluorine modified polymer is preferably used, and as a concrete example, BYK-340 (trade name, manufactured by BYK Japan KK) may be mentioned.

Although the silicone-based surfactant is not particularly limited, a polysiloxane-based compound is preferably mentioned. Although the polysiloxane-based compound is not particularly limited, for example, a polyether modified organosiloxane may be mentioned. As a commercial product of the polyether modified organosiloxane, for example, there may be mentioned BYK-306, BYK-307, BYK-333, BYK-341, BYK-345, BYK-346, or BYK-348 (trade name, manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.), or Silface SAG503A or Silface SAG014 (trade name, manufactured by Nissin Chemical Industry Co., Ltd.).

The surfactants mentioned above may be used alone, or at least two types thereof may be used in combination. In addition, among the surfactants mentioned above by way of example, a surfactant functioning as a defoaming agent may also be used. As the defoaming agent described above, for example, Surfynol DF110D (trade name, manufactured by Air Products Japan, K.K.) may be mentioned.

When the surfactant is contained, a content thereof with respect to the total mass of the ink jet ink composition is preferably set to 0.1 to 1.5 percent by mass in total.

### Resin

The color ink composition may also contain a resin. As the resin, for example, there may be mentioned an urethane-based resin, an acrylic-based resin (including a styrene-acrylic-based resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, or an ethylene-vinyl acetate-based resin. Among those resins mentioned above, an urethane-based resin, an acrylic-based resin, a polyolefin-based resin, or a polyester-based resin is preferable. Although those resins each may be a water-soluble resin and may also be in the form of resin particles, a resin in the form of particles is preferable. Although being frequently handled in the form of emulsion, the resin particles may also be handled in the form of powder. In addition, the resin may be used alone, or at least two types thereof may be used in combination.

The urethane-based resin is a generic name of a resin having an urethane bond. As the urethane-based resin, for example, there may be used a polyether type urethane resin having an ether bond in its main chain besides an urethane bond, a polyester type urethane resin having an ester bond in its main chain besides an urethane bond, or a polycarbonate type urethane resin having a carbonate bond in its main chain besides an urethane bond. In addition, as the urethane-based resin, a commercial product may also be used. For example, as the commercial product, there may be used Superflex 210, 460, 460s, 840, or E-4000 (trade name, manufactured by DKS Co., Ltd.), Resamine D-1060, D-2020, D-4080, D-4200, D-6300, or D-6455 (trade name, Dainichiseika Color & Chemicals Mfg. Co., Ltd.), Takelac WS-6021 or W-512-A-6 (trade name, manufactured by Mitsui Chemicals Polyurethanes, Inc.), Suncure 2710 (trade name, manufactured by Lubrizol), or Permarine UA-150 (trade name, manufactured by Sanyo Chemical Industries, Ltd.).

The acrylic-based resin is a generic name of a polymer obtained by polymerization using at least an acrylic-based monomer, such as (meth)acrylic acid or a (meth)acrylate ester, as one component, and for example, a resin obtained from an acrylic-based monomer or a copolymer obtained from an acrylic-based monomer and another monomer may be mentioned. For example, an acryl-vinyl-based resin which is a copolymer obtained from an acrylic-based monomer and a vinyl-based monomer may be mentioned. In addition, as the vinyl-based monomer, for example, styrene may be mentioned.

As the acrylic-based monomer, for example, acrylamide or acrylonitrile may also be used. For a resin emulsion using an acrylic-based resin as a raw material, a commercial product may also be used, and for example, a commercial product selected from FK-854 (trade name, manufactured by Chuorika Kougyo Co., Ltd.), Movinyl 6969D, 6899D, 952B, and 718A (trade names, manufactured by The Nippon Synthetic Chemical Industry Co., Ltd.), and Nipol LX852 and LX874 (trade names, manufactured by Zeon Corporation) may be used.

In addition, in this specification, the acrylic-based resin may also include a styrene-acrylic-based resin which will be described below.

The styrene-acrylic-based resin is a copolymer obtained from a styrene monomer and a (meth)acrylic-based monomer, and for example, a styrene-acrylic acid copolymer, a styrene-methacrylic acid copolymer, a styrene-methacrylic acid-acrylate ester copolymer, a styrene-α-methylstyrene-acrylic acid copolymer, or a styrene-α-methylstyrene-acrylic acid-acrylate ester copolymer may be mentioned. As the styrene-acrylic-based resin, a commercial product may also be used, and for example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, manufactured by BASF), Movinyl 966A or 975N (trade name, manufactured by The Nippon Synthetic Chemical Industry Co., Ltd.), or Vinyblan 2586 (trade name, manufactured by Nissin Chemical Industry Co., Ltd.) may be used.

The polyolefin-based resin is a resin having a structure skeleton of an olefin, such as ethylene, propylene, or butylene, and may be appropriately selected and used from known resins. As the olefin-based resin, a commercial product may also be used, and for example, Arrowbase CB-1200 or CD-1200 (trade name, manufactured by Unitika Ltd.) may be used.

In addition, the resin may be supplied in the form of emulsion, and as an example of a commercial product of the resin emulsion as described above, for example, there may be mentioned Microgel E-1002 or E-5002 (trade name, manufactured by Nippon Paint Co., Ltd., styrene-acrylic-based resin emulsion); Boncoat 4001 (trade name, manufactured by DIC Corporation, acrylic-based resin emulsion); Boncoat 5454 (trade name, manufactured by DIC Corporation, styrene-acrylic-based resin emulsion); Polysol AM-710, AM-920, AM-2300, AP-4735, AT-860, or PSASE-4210E (acrylic-based resin emulsion), Polysol AP-7020 (styrene-acrylic resin emulsion), Polysol SH-502 (vinyl acetate resin emulsion), Polysol AD-13, AD-2, AD-10, AD-96, AD-17, or AD-70 (ethylene vinyl acetate resin emulsion), or Polysol PSASE-6010 (ethylene-vinyl acetate resin emulsion) (trade name, manufactured by Showa Denko K.K.); Polysol SAE1014 (trade name, styrene-acrylic-based resin emulsion, manufactured by Zeon Corporation); Saivinol SK-200 (trade name, acrylic-based resin emulsion), manufactured by Saiden Chemical Industry Co., Ltd.); AE-120A (trade name, manufactured by JSR Corporation, acrylic resin emulsion); AE373D (trade name, manufactured by Emulsion Technology Co., Ltd., carboxy modified styrene-acrylic resin emulsion); Seikadyne 1900W (trade name, manufactured by Dainichiseika Color & Chemicals Mfg. Co., Ltd., ethylene-vinyl acetate resin emulsion); Vinyblan 2682 (acrylic resin emulsion), Vinyblan 2886 (vinyl acetate-acrylic resin emulsion), Vinyblan 5202 (acetic acid acrylic resin emulsion) (trade name, manufactured by Nissin Chemical Industry Co., Ltd.,); Elitel KA-5071S, KT-8803, KT-9204, KT-8701, KT-8904, or KT-0507 (trade name, manufactured by Unitika Ltd., polyester resin emulsion); Hitech SN-2002 (trade name, manufactured by Toho Chemical Industry Co., Ltd., polyester resin emulsion); Takelac W-6020, W-635, W-6061, W-605, W-635, or W-6021 (trade name, manufactured by Mitsui Chemicals Polyurethanes, Inc., urethane-based resin emulsion); Superflex 210, 870, 800, 150, 420, 460, 470, 610, or 700 (trade name, manufactured by DKS Co., Ltd., urethane-based resin emulsion); Permarin UA-150 (manufactured by Sanyo Chemical Industries, Ltd., urethane-based resin emulsion); Sancure 2710 (manufactured by Lubrizol Japan Ltd., urethane-based resin emulsion); NeoRez R-9660, R-9637, or R-940 (manufactured by Kusumoto Chemicals, Ltd., urethane-based resin emulsion); Adeka Bontighter HUX-380 or 290K (trade name, manufactured by ADEKA Corporation, urethane-based resin emulsion); Movinyl 966A or Movinyl 7320 (trade name, manufactured by The Nippon Synthetic Chemical Industry Co., Ltd.); Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, manufactured by BASF); NK Binder R-5HN (trade name, manufactured by Shin-Nakamura Chemical Co., Ltd.); or Hydran WLS-210 (trade name, non-crosslinkable polyurethane: manufactured by DIC Corporation).

A glass transition temperature Tg of the resin is preferably 0° C. or more, more preferably 30° C. or more, even more preferably 50° C. or more, further preferably 60° C. or more, and particularly preferably 70° C. or more. When the glass transition temperature Tg of the resin is particularly 60° C. or more, the dry abrasion resistance tends to be made more excellent. In addition, a clogging recovery property also tends to be made more excellent.

Although being not particularly limited, an upper limit of the glass transition temperature Tg of the resin is preferably 150° C. or less, more preferably 100° C. or less, and further preferably 80° C. or less.

The measurement of the glass transition temperature is performed, for example, in accordance with JIS K7121 (testing methods for transition temperatures of plastics) using a differential scanning calorimeter “DSC7000” manufactured by Hitachi High-Tech Science Corporation.

A content of the resin with respect to the total mass of the color ink composition is as a solid content, preferably 0.1 to 20 percent by mass, more preferably 1.0 to 15.0 percent by mass, further preferably 2.0 to 10.0 percent by mass, and particularly preferably 3.0 to 8.0 percent by mass.

### Wax

The color ink composition may also contain a wax. As the wax, for example, a wax to be dissolved in the ink or a wax to be dispersed in the form of fine particles, such as an emulsion, may be mentioned. Since the wax as described above is used, a recorded matter having a more excellent abrasion resistance tends to be obtained.

Although the wax is not particularly limited, for example, there may be mentioned an ester wax formed between a higher aliphatic acid and a higher monovalent or divalent alcohol, a paraffin wax, a microcrystalline wax, a polyolefin wax, or a mixture of those mentioned above.

As the polyolefin wax, for example, a wax manufactured from an olefin, such as ethylene, propylene, or butylene, or a derivative thereof, or a wax in the form of copolymer thereof may be mentioned, and in particular, for example, a polyethylene-based wax, a polypropylene-based wax, or a polybutylene-based wax may be mentioned. As the polyolefin wax, a commercial product may also be used, and in particular, for example, Nopcoat PEM17 (trade name, manufactured by San Nopco Ltd.), Chemipal W4005 (trade name, manufactured by Mitsui Chemicals, Inc.), AQUACER 515, AQUACER 539, or AQUACER 593 (trade name, manufactured by BYK Japan KK), or Hitech E7100S, E-6314, or E-6500 (polyethylene wax, manufactured by Toho Chemical Industry Co., Ltd.) may be used.

When the wax is contained, a content thereof with respect to the total mass of the color ink composition is preferably 0.1 to 5 percent by mass, more preferably 0.2 to 4 percent by mass, and further preferably 0.3 to 3 percent by mass. When the content of the wax is in the range described above, the abrasion resistance is preferably improved, and while the viscosity of the ink is maintained low, the ejection stability and the clogging recovery property preferably tend to be made excellent.

### Other Materials

The color ink composition may contain, if needed, a pH adjuster, a sugar, an urea, a chelating agent, an antiseptic/fungicide agent, an antirust agent, and/or the like.

Although the pH adjuster is not particularly limited, an appropriate combination among an acid, a base, a weak acid, and a weak base may be mentioned. As examples of an acid and a base used for the combination as described above, for example, there may be used an inorganic acid, such as sulfuric acid, hydrochloric acid, or nitric acid; an inorganic base, such as lithium hydroxide, sodium hydroxide, potassium hydroxide, potassium dihydrogen phosphate, sodium dihydrogen phosphate, potassium carbonate, sodium carbonate, sodium hydrogen carbonate, or ammonia; an organic base, such as triethanolamine, diethanolamine, monoethanolamine, tripropanolamine, triisopropanolamine, diisopropanolamine, or tris(hydroxymethyl)aminomethane (THAM); an organic acid, such as adipic acid, citric acid, succinic acid, or lactic acid; a Good's buffer solution, such as N,N-bis(2-hydroxyethyl)-2-aminoethane sulfonic acid (BES), 4-(2-hydroxyethyl)-1-piperazineethane sulfonic acid (HEPES), morpholinoethane sulfonic acid (MES), carbamoylmethyliminobisacetic acid (ADA), piperazine-1,4-bis(2-ethane sulfonic acid) (PIPES), N-(2-acetoamide)-2-aminoethane sulfonic acid (ACES), cholamine chloride, N-tris(hydroxymethyl)methyl-2-aminoethane sulfonic acid (TES), acetamide glycine, tricine, glycine amide, or bicine; or a phosphoric acid buffer solution, a citric acid buffer solution, or a tris buffer solution. Furthermore, among those compounds mentioned above, as a part or the entire pH adjuster, a tertiary amine, such as triethanolamine or triisopropanolamine, or a carboxyl group-containing organic acid, such as adipic acid, citric acid, succinic acid, or lactic acid, is preferably contained since the pH-buffering effect can be more stably obtained.

As the urea, for example, there may be mentioned urea, ethyleneurea, tetramethylurea, thiourea, or 1,3-dimethyl-2-imidazolidinone, and in addition, a betaine, such as trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, or acetylcarnitine, may also be mentioned.

As a concrete example of the saccharide, for example, there may be mentioned glucose, mannose, fructose, ribose, xylose, arabinose, galactose, aldonic acid, glucitol (sorbit), maltose, cellobiose, lactose, sucrose, trehalose, or maltotriose.

As the chelating agent, for example, there may be mentioned ethylenediaminetetraacetic acid or its salt (such as ethylenediaminetetraacetic acid dihydrogen disodium, or a nitrilotriacetic acid salt, a hexametaphosphoric acid salt, a pyrophosphoric acid salt, or a metaphosphoric acid salt of ethylene diamine).

As the antiseptic agent and the fungicide, for example, there may be mentioned sodium benzoic acid, sodium pentachlorophenol, sodium 2-pyridinethiol-1-oxide, sodium sorbate, sodium dehydroacetate, Proxel CRL, Proxel BDN, Proxel GXL, Proxel XL-2, Proxel IB, or Proxel TN (trade name, manufactured by Lonza KK.), or 4-chloro-3-methylphenol (such as Preventol CMK, manufactured by Bayer).

As an example of the antirust agent, for example, there may be mentioned benzotriazole, acidic sulfite, sodium thiosulfate, ammonium thioglycolate, diisopropylammonium nitrite, pentaerythritol tetranitrate, or dicyclohexylammonium nitrite. Among those mentioned above, benzotriazole is particularly preferable.

As other additives, for example, a viscosity adjuster, a fungicide, an antioxidant, an anti-reducing agent, an oxygen absorber, an UV absorber, and/or a solubilizing agent may be mentioned, and among those mentioned above, at least one thereof may be contained.

### 1.2.1. (4) Manufacturing and Physical Properties

The color ink composition may be prepared in a manner such that the individual components described above are mixed together in an arbitrary order, and if needed, impurities are then removed by filtration or the like. As a mixing method of the individual components, there may be preferably used a method in which the individual components are stirred and mixed together after being sequentially added in a container equipped with a stirring device, such as a mechanical stirrer or a magnetic stirrer. As a filtration method, for example, a centrifugal filtration or a filter filtration may be performed, if needed.

In view of the balance between the image quality and the reliability as the ink jet recording ink, a surface tension (static surface tension) of the color ink composition at 20° C. is preferably 18 to 40 mN/m, more preferably 20 to 35 mN/m, and further preferably 22 to 33 mN/m. In addition, the surface tension may be measured, for example, using an automatic surface tensiometer CBVP-Z (trade name, manufactured by Kyowa Interface Science Co., Ltd.) in a manner such that in an environment at 20° C., a surface tension obtained when a platinum plate is wetted with an ink is confirmed.

The surface tension of the color ink composition is preferably adjusted so that the difference in surface tension from the clear ink compositions which will be described later is 2 mN/m or less. Accordingly, a color transfer of the color ink composition to the non-image portion to which the color ink composition is not adhered can be further suppressed.

A viscosity of the color ink composition at 20° C. is preferably 3 to 10 mPa·s and more preferably 3 to 8 mPa·s. In addition, the viscosity can be measured, for example, using a viscoelastic tester MCR-300 (trade name, manufactured by Pysica) in an environment at 20° C.

### 1.2.2. Adhesion Mode

The ink adhesion step is performed by an ink jet method. A region to which the color ink composition is adhered by the ink adhesion step is called an image portion. The ink adhesion step and the clear ink adhesion step which will be described later may be performed on predetermined regions of the recording medium in an arbitrary order or at the same time. In the case described above, after the color ink composition is adhered to the image portion, when the clear ink composition is adhered, an effect of suppressing bleeding can be more expected. However, in this case, a time required for recording is unfavorably made longer. Hence, it is more preferable when the clear ink composition is not adhered to the image portion, or when an adhesion amount of the clear ink composition to the image portion is made smaller than that thereof to the non-image portion. In both cases described above, when the adhesion of the clear ink composition to the non-image portion is performed at the same time when the adhesion of the color ink composition to the image portion is performed, the time required for recording is not made longer.

An adhesion amount of the color ink composition in the color ink adhesion step is preferably 15 to 120 g/m², more preferably 30 to 80 g/m², and further preferably 30 to 60 g/m².

In addition, a region having an adhesion amount of 3 to 15 mg/inch² is preferably included, and a region having an adhesion amount of 5 to 10 mg/inch² is more preferably included. In addition, the maximum adhesion amount of the color ink composition in the recording is also preferably in the range described above.

### 1.3. Clear Ink Adhesion Step

In the clear ink adhesion step, a water-based clear ink composition is ejected from the ink jet head and is adhered to the recording medium. In the clear ink adhesion step, to the non-image portion which is a region other than the image portion which is a region of the recording medium to which the color ink composition is adhered, the clear ink composition is adhered.

### 1.3.1. Clear Ink Composition

The clear ink composition of this embodiment is a water-based composition which contains a resin and a wax and contains no polyol having a standard boiling point of 280° C. or more functioning as an organic solvent at a content of 0.5 percent by mass or more with respect to a total mass of the clear ink composition. Unlike the color ink composition, the clear ink composition is not an ink composition to color the recording medium. Hence, a content of the colorant in the clear ink composition is preferably 0.1 percent by mass or less, more preferably 0.05 percent by mass or less, and further preferably 0.01 percent by mass or less, and may also be 0 percent by mass. The clear ink composition may have a composition similar to that used for the color ink composition other than the colorant.

### 1.3.1. (1) Resin

The clear ink composition contains a resin. The type and the like of the resin are similar to those described in the above section of the color ink composition, and detailed description will be omitted.

A content of the resin in the clear ink composition with respect to the total mass thereof as a solid content is preferably 0.1 to 20 percent by mass, more preferably 1.0 to 15.0 percent by mass, even more preferably 2.0 to 10.0 percent by mass, and further preferably 3.0 to 8.0 percent by mass.

In addition, as for the content of the resin in the clear ink composition, a total content of the resin described above and the wax contained in the clear ink composition with respect to the total mass thereof is preferably 3 to 15 percent by mass, more preferably 4 to 10 percent by mass, and further preferably 5 to 9 percent by mass. Accordingly, the color transfer of the color ink composition to the non-image portion can be further suppressed.

Furthermore, a mass ratio (wax/resin) of the resin and the wax contained in the clear ink composition is preferably 0.15 or more, more preferably 0.2 or more, even more preferably 0.25 or more, and further preferably 0.33 or more. In addition, the mass ratio described above is preferably 0.8 or less, more preferably 0.6 or less, and further preferably 0.4 or less. Accordingly, the color transfer of the color ink composition to the non-image portion can be further suppressed.

### 1.3.1. (2) Wax

The clear ink composition contains a wax. The type, the content, and the like of the wax are similar to those described in the above section of the color ink composition, and detailed description will be omitted.

The wax contained in the clear ink composition has a melting point of preferably 115° C. or more, more preferably 120° C. or more, and further preferably 125° C. or more. Although being not particularly limited, an upper limit of the melting point of the wax contained in the clear ink composition is preferably 160° C. or less, more preferably 140° C. or less, and further preferably 130° C. or less. Furthermore, the wax contained in the clear ink composition is more preferably a polyolefin wax and is preferably selected, for example, from a polypropylene, a polyethylene, and a copolymer thereof. Accordingly, the color transfer of the color ink composition to the non-image portion can be further suppressed.

The wax contained in the clear ink composition has a volume average particle diameter (D50) of preferably 40 nm or more, more preferably 50 nm or more, and further preferably 60 nm or more. In addition, although an upper limit of the volume average particle diameter (D50) of the wax contained in the clear ink composition is not particularly limited as long as an ink jet method can be applied, the upper limit described above is, for example, 200 nm or less and preferably 100 nm or less. Accordingly, the surface irregularity of the recording medium can be more easily planarized, and the color transfer of the color ink composition to the non-image portion can be further suppressed.

A content of the wax in the clear ink composition with respect to the total mass thereof as a solid content is preferably 0.1 to 20 percent by mass, more preferably 1.0 to 15.0 percent by mass, even more preferably 2.0 to 10.0 percent by mass, and further preferably 3.0 to 8.0 percent by mass.

### 1.3.1. (3) Water

The clear ink composition is a water-based composition. The “water-based” composition indicates a composition containing at least water as a solvent component and may contain water as a primary solvent component. The water is similar to that described in the above section of the color ink composition, and detailed description will be omitted.

### 1.3.1. (4) Polyol

The clear ink composition contains no polyol having a standard boiling point of 280° C. or more functioning as an organic solvent at a content of 0.5 percent by mass or more with respect to the total mass of the clear ink composition. The polyol is similar to that described in the above section of the color ink composition, and detailed description will be omitted.

As the polyol having a standard boiling point of 280° C. or more, for example, glycerin may be mentioned. A content of the polyol having a standard boiling point of 280° C. or more functioning as an organic solvent is, with respect to the total mass of the clear ink composition, preferably 0.3 percent by mass or less, more preferably 0.1 percent by mass or less, further preferably 0.05 percent by mass or less, and particularly preferably 0 percent by mass.

### 1.3.1. (5) Other Components

The clear ink composition may contain, besides the polyol having a standard boiling point of 280° C. or more, components similar to those described in the section of “1.2.1. (3) OTHER COMPONENTS”. The other components to be contained in the clear ink composition can be described when the “color ink composition” in the above section is read as the “clear ink composition”.

### 1.3.1. (6) Manufacturing and Physical Properties

The clear ink composition may be prepared in a manner such that the individual components described above are mixed together in an arbitrary order, and if needed, impurities are then removed by filtration or the like. As a mixing method of the individual components, there may be preferably used a method in which the individual components are stirred and mixed together after being sequentially added in a container equipped with a stirring device, such as a mechanical stirrer or a magnetic stirrer. As a filtration method, for example, a centrifugal filtration or a filter filtration may be performed, if needed.

In view of the balance between the image quality and the reliability as the ink jet recording ink, a surface tension (static surface tension) of the clear ink composition at 20° C. is preferably 18 to 40 mN/m, more preferably 20 to 35 mN/m, and further preferably 22 to 33 mN/m. In addition, the surface tension may be measured, for example, using an automatic surface tensiometer CBVP-Z (trade name, manufactured by Kyowa Interface Science Co., Ltd.) in a manner such that in an environment at 20° C., a surface tension obtained when a platinum plate is wetted with an ink is confirmed.

The surface tension of the clear ink composition is more preferably adjusted so that the difference in surface tension from the color ink compositions described above is 2 mN/m or less. Accordingly, the color transfer of the color ink composition to the non-image portion to which the color ink composition is not adhered can be further suppressed.

A viscosity of the clear ink composition at 20° C. is preferably 3 to 10 mPa·s and more preferably 3 to 8 mPa·s. In addition, the viscosity can be measured, for example, using a viscoelastic tester MCR-300 (trade name, manufactured by Pysica) in an environment at 20° C.

### 1.3.2. Adhesion Mode

The clear ink adhesion step is performed by an ink jet method. In the clear ink adhesion step, the clear ink composition is adhered at least to the non-image portion which is a region other than the image portion. In addition, the clear ink composition may also be adhered to the image portion. The timings at which the ink adhesion step and the clear ink adhesion step are performed are as described above.

An adhesion amount of the clear ink composition in the clear ink adhesion step is preferably 15 to 120 g/m², more preferably 30 to 80 g/m², and further preferably 30 to 60 g/m².

In addition, the adhesion amount of the clear ink composition to the non-image portion is preferably 0.1 to 7 mg/inch², more preferably 0.5 to 5 mg/inch², even more preferably 0.8 to 3 mg/inch², and further preferably 1 to 2 mg/inch².

In addition, the adhesion amount of the clear ink composition to the image portion is preferably 0.1 to 7 mg/inch², more preferably 0.3 to 5 mg/inch², even more preferably 0.5 to 2 mg/inch², and further preferably 0.6 to 1 mg/inch².

### 1.4. Relationship Between Image Portion and Non-Image Portion

In the recording method of this embodiment, a total adhesion amount of the resin and the wax contained in the clear ink composition in the non-image portion is preferably 0.6 mg/inch² or less, more preferably 0.4 mg/inch² or less, even more preferably 0.3 mg/inch² or less, and further preferably 0.2 mg/inch² or less. Accordingly, the color transfer of the color ink composition to the non-image portion can be sufficiently suppressed.

In the recording method of this embodiment, the region in the non-image portion to which the clear ink composition is adhered preferably includes an area having a width of 2 cm or more from the edge of the periphery of the image portion, more preferably includes an area having a width of 3 cm or more from the edge of the periphery of the image portion, and further preferably includes an area having a width of 5 cm or more from the edge of the periphery of the image portion. That is, when attention is paid on a certain image portion in the recording region in which the recording is performed by the recording method, the region to which the clear ink composition is adhered preferably includes an area having a predetermined width or more from the edge of the periphery of the image portion described above.

Although the region to which the clear ink composition is adhered in the non-image portion is particularly preferably the entire area of the non-image portion, even when the region described above is not the entire area of the non-image portion, the color transfer of the color ink composition to the non-image portion can be suppressed.

Furthermore, in the recording method of this embodiment, the adhesion amount of the clear ink composition to the image portion adjacent to the non-image portion to which the clear ink composition is adhered is preferably equal to or less than the adhesion amount of the clear ink composition to the above non-image portion. When the adhesion amount of the clear ink compositions is controlled as described above, the color transfer of the color ink composition to the non-image portion can also be suppressed. As the reason for this, in this recording method, it is assumed such that the adhesion of the clear ink composition to the image portion is effective but is not always necessary. That is, the assumption described above is considered based on the fact that since the surface of the recording medium is irregular, when the image portion is rubbed, although the color ink composition is transferred, peeling of the ink of the image portion is not made conspicuous by this transfer, and the stain of the non-image portion is conspicuous. On the other hand, it is also assumed that when the clear ink composition is adhered to the image portion, depending on the adhesion amount thereof, the total adhesion amount to the image portion is increased, and as a result, the bleeding is generated in the image portion.

### 1.5. Functional Effect and the Like

According to the recording method of this embodiment, even when a non-absorbing or a low-absorbing recording medium including a substrate with an in-plane surface roughness (Sa) of 0.2 μm or more is used, a recorded matter that can suppress the color transfer of the color ink composition to the non-image portion can be obtained.

### 1.6. Other Steps

The recording method according to this embodiment may include, besides the ink adhesion step and the clear ink adhesion step, the following steps.

### Primary Drying Step

The recording method according to this embodiment may also include a primary drying step of drying the composition adhered to the recording medium by a drying mechanism. The primary drying step is a step of rapidly drying the ink, for example, by heating the recording medium before each adhesion step or by heating the recording medium and/or blowing a wind thereto in each adhesion step or at an early stage after the adhesion to the recording medium.

The primary drying step is a step of drying at least a part of the solvent component of the composition adhered to the recording medium so as to at least decrease the fluidity of the composition. The primary drying step may be performed in a manner such that the composition is adhered to a heated recording medium or in a manner such that the drying is promoted at an early stage after the adhesion of the composition.

In the primary drying step, the drying of a composition droplet landed on the recording medium is preferably started within 0.5 seconds at the latest from the landing of the ink droplet. A drying unit (drying mechanism) to dry the composition on the recording medium is not particularly limited, and for example, a platen heater, a hot wind heater, or an IR heater each having a heating function or an air blower having no heating function may be mentioned.

As the type of drying mechanism, for example, there may be mentioned a conduction type to heat the recording medium by conducting heat thereto from a member in contact with the recording medium, a radiation type to heat the recording medium by radiating radiant rays, such as IR rays, to the recording medium, or an air blowing type to blow a wind to the recording medium.

As the air blowing type, for example, a method to heat the recording medium while a hot wind is blown thereto or a method to promote drying of the ink by an ordinary temperature wind without heating may be mentioned. In the method in which the heating is not performed, the ejection stability can be preferably suppressed from being degraded due to the drying of the ink in nozzles of an ink jet head. One of the conduction type and the radiation type is also preferably performed together with the air blowing type. When those types are used in combination, the air blowing type may also be preferably performed without heating.

In the primary drying step, a surface temperature of the recording medium is preferably 60° C. or less, more preferably 55° C. or less, even more preferably 40° C. or less, further preferably 35° C. or less, and particularly preferably 30° C. or less. On the other hand, the surface temperature described above is preferably 20° C. or more and more preferably 25° C. or more. Furthermore, the surface temperature described above is preferably 30° C. to 50° C. and more preferably 40° C. to 45° C. In addition, alternatively, the surface temperature described above is particularly preferably 25° C. to 28° C.

Since the surface temperature of the recording medium is in the range described above, the drying property is further improved, and the abrasion resistance of a recorded matter to be obtained tends to be further improved. In addition, the clogging recovery property, the ejection stability, and the color development property are also preferably made more excellent.

In addition, the primary drying step may be not performed, or a step including heating may also be not performed as the primary drying step, and in the case described above, the surface temperature of the recording medium over the platen may also be set in the range described above.

In addition, when the air blowing type is used, a wind velocity in the vicinity of the recording medium is preferably 0.2 m/s or more. On the other hand, the wind velocity described above is preferably 20 m/s or less, more preferably 0.5 to 10 m/s, even more preferably 1 to 5 m/s, and further preferably 2 to 3 m/s. A wind temperature is preferably 45° C. or less, more preferably 40° C. or less, further preferably 32° C. or less, and particularly preferably 20° C. to 27° C.

### Secondary Heating Step

The recording method according to this embodiment may also include a heating step (secondary heating step) of heating the recording medium to which the color ink composition and the clear ink composition are adhered. The secondary heating step is a step of performing a sufficient heating to complete the recording so that the recorded matter is ready to be used. In addition, the secondary heating step is a step of sufficiently drying the solvent component of the ink and heating the resin and the like contained in the ink to form a coating film thereof.

The secondary heating step is preferably started more than 0.5 seconds after the adhesion of the ink to the recording medium. For example, after the adhesion of the ink to the recording region of the recording medium is thoroughly completed, the heating is preferably started more than 0.5 seconds on the region described above.

A surface temperature of the recording medium in the secondary heating step is preferably 50° C. or more, more preferably 60° C. or more, and further preferably 70° C. or more. In the secondary heating step, when the surface temperature of the recording medium is increased to 60° C. or more, the drying property is made excellent, and the wet abrasion resistance tends to be made more preferable. An upper limit of the surface temperature is preferably 100° C. or less and more preferably 90° C. or less.

In addition, as a secondary heating mechanism, for example, a conduction type, a radiation type, or an air blowing type may be used.

### 2. Recording Apparatus

A recording apparatus according to this embodiment is a recording apparatus to perform the recording method described above and includes the above color ink composition, the above clear ink composition, and an ink jet head to eject the color ink composition and the clear ink composition.

Hereinafter, one example of a recording apparatus suitably used for the recording method according to this embodiment will be described with reference to the drawings.

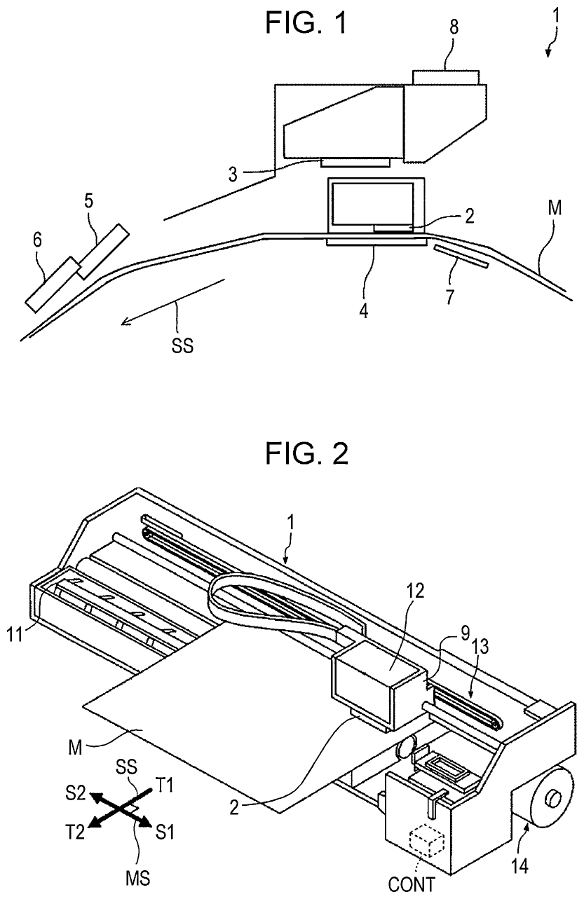

FIG. 1 is a schematic cross-sectional view showing an ink jet recording apparatus 1. FIG. 2 is a perspective view showing one example of the structure in the vicinity of a carriage of the ink jet recording apparatus 1 in FIG. 1. As shown in FIGS. 1 and 2, the ink jet recording apparatus 1 includes an ink jet head 2, an IR heater 3, a platen heater 4, a heating heater 5, a cooling fan 6, a pre-heater 7, a ventilation fan 8, a carriage 9, a platen 11, a carriage transfer mechanism 13, a transport device 14, and a control portion CONT. All operation of the ink jet recording apparatus 1 is controlled by the control portion CONT shown in FIG. 2.

The ink jet head 2 includes an ink jet head 2a to eject the color ink composition and an ink jet head 2b to eject the clear ink composition, and since the color ink composition and the clear ink composition are ejected from nozzles of the respective ink jet heads and are adhered to a recording medium M, the recording can be performed thereon.

In this embodiment, the ink jet head 2 is a serial type ink jet head and is scanned a plurality of times in a main scanning direction relatively to the recording medium M so that the color ink composition and the clear ink composition are adhered to the recording medium M. The ink jet head 2 is mounted on the carriage 9 shown in FIG. 2. The ink jet head 2 is scanned a plurality of times in the main scanning direction relatively to the recording medium M by the operation of the carriage transfer mechanism 13 to transfer the carriage 9 in a medium width direction of the recording medium M. The medium width direction is the main scanning direction of the ink jet head 2. The scanning in the main scanning direction is also called the main scanning.

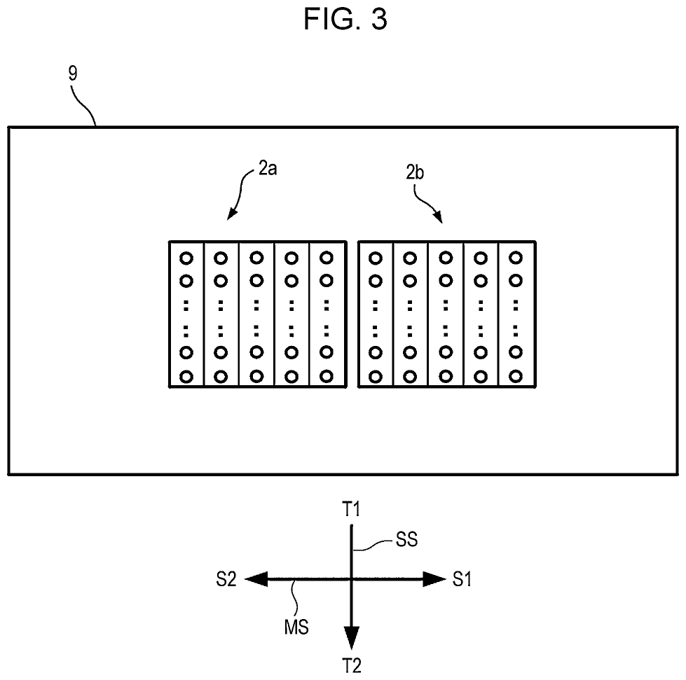

FIG. 3 shows the arrangement in which the ink jet head 2a to eject the color ink composition and the ink jet head 2b to eject the clear ink composition are disposed adjacent to each other at the same position with respect to the transport direction (T2 direction) of the recording medium M. When being projected in the main scanning direction, the ink jet head 2a and the ink jet head 2b have portions to be overlapped with each other in the transport direction (T2 direction).

For example, according to the arrangement as described above, by the mode (the second adhesion mode) in which the color ink composition and the clear ink composition are simultaneously adhered to the recording medium, the color ink composition and the clear ink composition can be adhered thereto. That is, the color ink composition and the clear ink composition are adhered to the same main scanning region of the recording medium by the same main scanning. In the case described above, when the clear ink composition is adhered to the image portion, the color ink composition and the clear ink composition are laminated and adhered to the same main scanning region of the recording medium by the same main scanning.

In addition, the nozzle lines shown in FIG. 3 are nozzle lines of the respective ink jet heads to eject the inks.

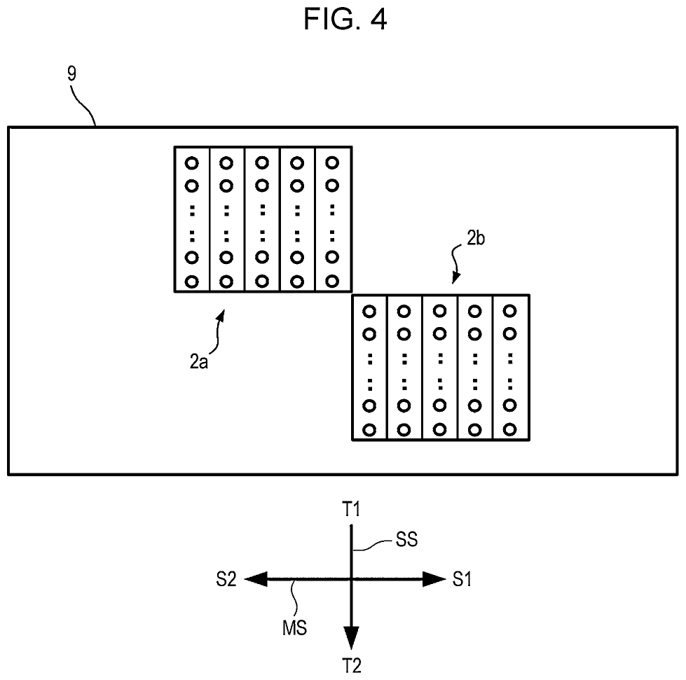

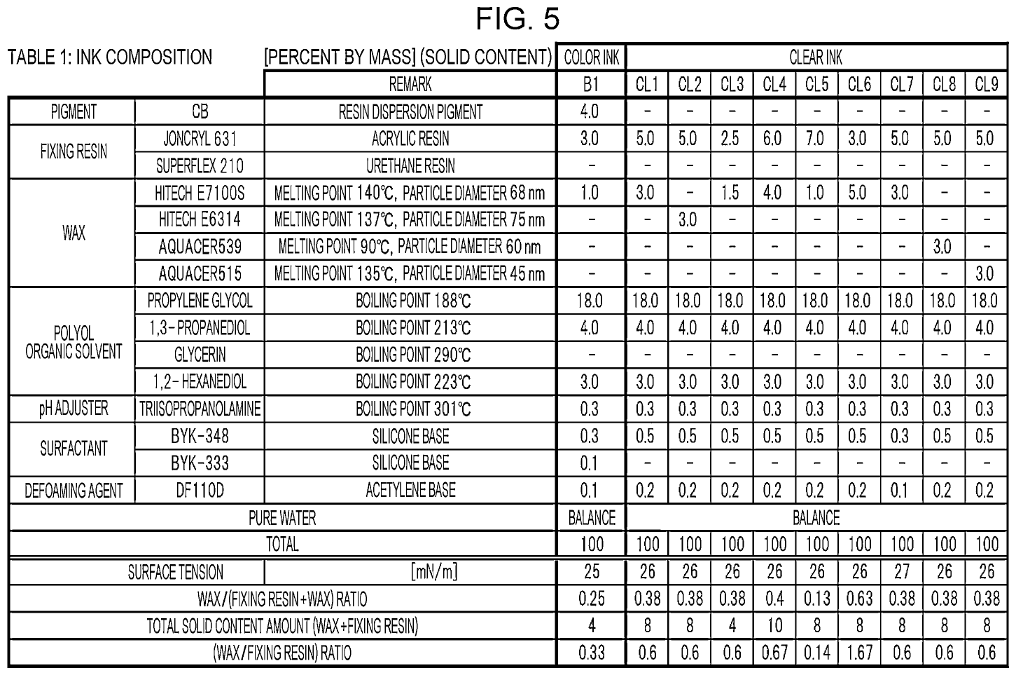

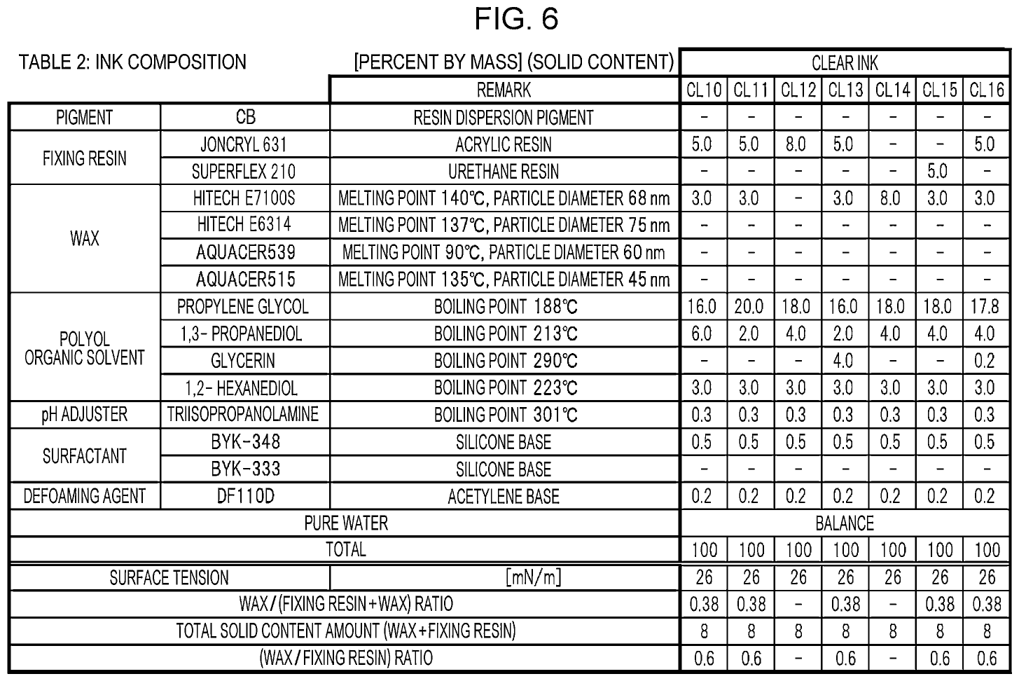

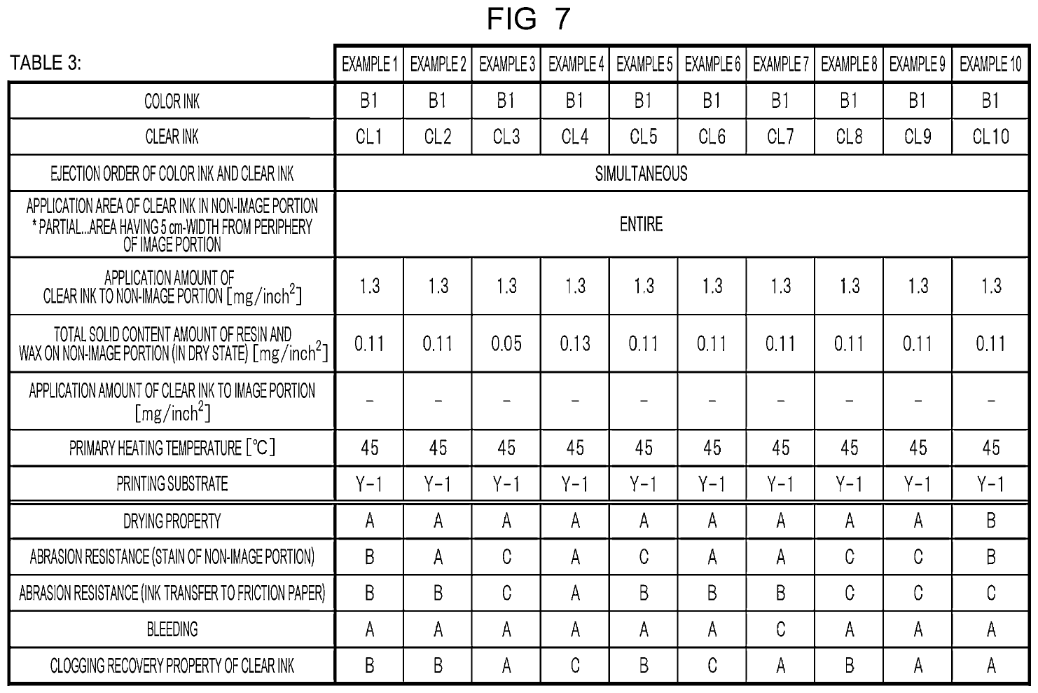

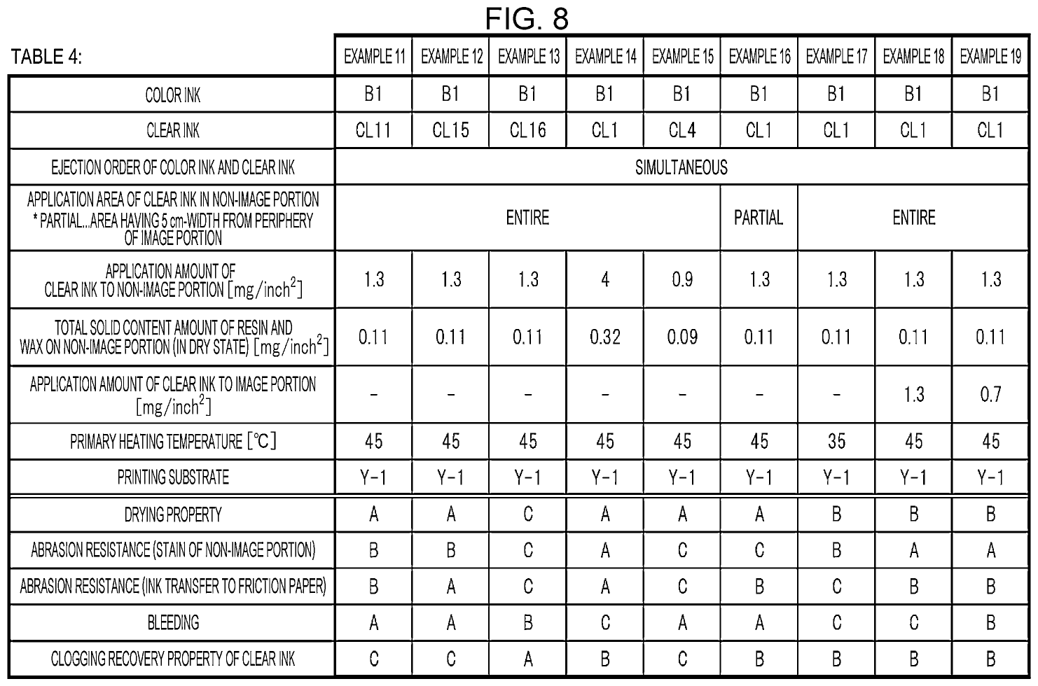

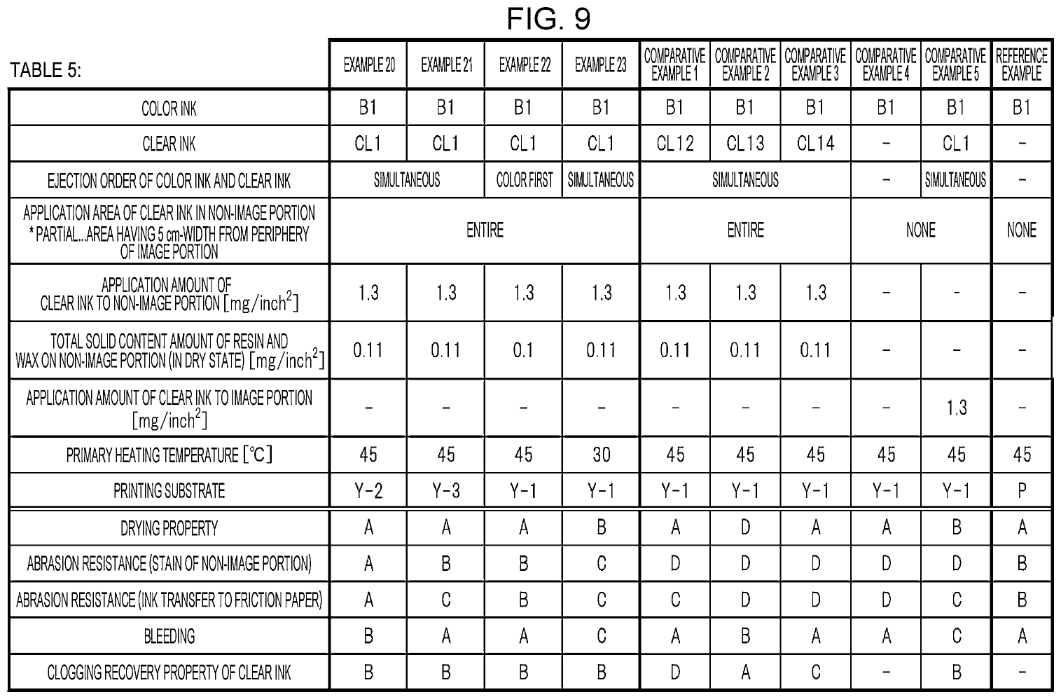

FIG. 4 shows the arrangement in which the ink jet head 2b to eject the clear ink composition is disposed downstream of the ink jet head 2a to eject the color ink composition with respect to the transport direction (T2 direction) of the recording medium M. When being projected in the main scanning direction, the ink jet head 2a and the ink jet head 2b have not portions to be overlapped with each other in the transport direction (T2 direction).

For example, according to the arrangement as described above, by the mode (the first adhesion mode) in which the color ink composition and the clear ink composition are sequentially adhered and laminated to the recording medium, the color ink composition and the clear ink composition can be adhered. That is, the color ink composition is adhered to a main scanning region by a certain main scanning, and by the following main scanning, the clear ink composition is adhered to the above main scanning region. In the case described above, when the clear ink composition is adhered to the image portion, the color ink composition is adhered to a main scanning region by a certain main scanning, and by the following main scanning, the clear ink composition is laminated and adhered to the above main scanning region.

In addition, the nozzle lines shown in FIG. 4 are nozzle lines of the respective ink jet heads to eject the inks.

In addition, the main scanning direction is a direction in which the carriage 9 mounting the ink jet head 2 is transferred. In FIG. 1, the main scanning direction is a direction intersecting a sub scanning direction which is the transport direction of the recording medium M shown by an arrow SS. In FIG. 2, the width direction of the recording medium M, that is, the direction represented by S1-S2, is a main scanning direction MS, and a direction represented by T1-T2 is a sub scanning direction SS. In addition, by one scanning in the main scanning direction, the scanning is performed in one of the directions represented by an arrow S1 and an arrow S2. In addition, since the main scanning of the ink jet head 2 and the sub scanning to transport the recording medium M are repeatedly performed a plurality of times, the recording can be performed on the recording medium M. That is, the color ink adhesion step and the clear ink adhesion step are carried out by performing the main scanning to transfer the ink jet head 2 in the main scanning direction a plurality of times and the sub scanning to transport the recording medium M in the sub scanning direction intersecting the main scanning direction a plurality of times.

A cartridge 12 to supply the inks to the ink jet head 2 includes a plurality of independent cartridges. The cartridge 12 is detachably fitted to the carriage 9 mounting the ink jet head 2. In the independent cartridges, different types of inks can be filled, and the inks are supplied to respective nozzles from the cartridge 12. In addition, in this embodiment, although the case in which the cartridge 12 is mounted in the carriage 9 is shown by way of example, the structure is not limited thereto, and the case in which the cartridge 12 is provided at a position other than that of the carriage 9, and the inks are supplied to the respective nozzles using supply tubes (not shown) may also be mentioned.

For the ejection from the ink jet head 2, a known method may be used. In this embodiment, a method to eject liquid droplets using vibration of a piezoelectric element, that is, an ejection method to form ink droplets by mechanical deformation of an electrostrictive element, is used.

The ink jet recording apparatus 1 includes, in order to dry the ink ejected from the ink jet head 2 and adhered to the recording medium M, the ventilation fan 8, the IR heater 3, and the platen heater 4. When those heaters described above, that is, the ventilation fan 8, the IR heater 3, and the platen heater 4, are appropriately used in combination, the primary drying step can be performed. In the primary drying step, the recording medium M is not always required to be heated, and the ventilation fan 8 may only be used to blow a wind at an ordinary temperature.

In addition, when the IR heater 3 is used, by radiation of infrared rays from an ink jet head 2 side, the recording medium M can be heated by a radiation type. Accordingly, although the ink jet head 2 is also liable to be heated at the same time, compared to the case in which the recording medium M is heated from a rear side thereof by the platen heater 4 or the like, the temperature can be increased without receiving the influence of the thickness of the recording medium M. In addition, various types of fans (such as the ventilation fan 8) may also be provided to dry the ink on the recording medium M by blowing a hot wind or a wind having the same temperature as that of the atmosphere to the recording medium M.

In order to rapidly dry the ink ejected from the ink jet head 2 and adhered to the recording medium M, the platen heater 4 can heat the recording medium M at a position facing the ink jet head 2 with the platen 11 interposed therebetween. The platen heater 4 is a heater capable of heating the recording medium M by a conduction type, and accordingly, the ink can be adhered to a heated recording medium M.

In addition, the surface temperature of the recording medium M by heating using the IR heater 3 and the platen heater 4 is preferably set in the range described in the above primary drying step.

The heating heater 5 is a heater to dry and fix the ink adhered to the recording medium M, that is, is a secondary heating heater. The heating heater 5 can be used in the secondary heating step. Since the heating heater 5 heats the recording medium M on which an image is recorded, moisture or the like contained in the ink can be rapidly evaporated and scattered, and by the resin contained in the clear ink composition, an ink film is formed. As described above, since the ink film is tightly fixed or adhered onto the recording medium M, the film forming property is made excellent, and hence, an excellent high quality image can be obtained in a short time.

The surface temperature of the recording medium M by heating using the heating heater 5 is preferably in the range described in the above secondary heating step. Since the temperature is in the range described above, a high quality image tends to be obtained in a short time.

The ink jet recording apparatus 1 may also include the cooling fan 6. After the ink recorded on the recording medium M is dried, since the ink on the recording medium M is cooled by the cooling fan 6, the ink coating film can be formed on the recording medium M with a good adhesion.

In addition, the ink jet recording apparatus 1 may also include the pre-heater 7 to heat the recording medium M in advance before the ink is adhered to the recording medium M. Furthermore, the ink jet recording apparatus 1 may also include the ventilation fan 8 to more efficiently dry the ink adhered to the recording medium M.

Under the carriage 9, the platen 11 to support the recording medium M, the carriage transfer mechanism 13 to transfer the carriage 9 relatively to the recording medium M, and the transport device 14 which is a roller to transport the recording medium M in the sub scanning direction are provided. The operation of the carriage transfer mechanism 13 and that of the transport device 14 are controlled by the control portion CONT.

In addition, in another embodiment, the ink jet recording apparatus may be a line type ink jet recording apparatus in which the ink jet head 2 is a line head. For example, in FIG. 1, the ink jet head 2 is a line head having a length equal to or longer than a recording width of the recording medium in the width direction, and the position of the line head 2 is fixed. The ink is ejected from the ink jet head 2 to the recording medium M which is transported and is adhered thereto. In the case described above, the recording is performed by one main scanning. When the ink jet head 2 is the line head, the structure other than that described above may be configured in a manner similar to that of the serial type described above.

According to the recording apparatus of this embodiment, even when a non-absorbing or a low-absorbing recording medium including a substrate with an in-plane surface roughness (Sa) of 0.2 μm or more is used, a recorded matter that can suppress the color transfer of the color ink composition to the non-image portion can be obtained.

### 3. Examples and Comparative Examples

Hereinafter, although the present disclosure will be described in detail with reference to Examples, the present disclosure is not limited thereto. Hereinafter, unless otherwise particularly noted, “part(s)” and “%” are each on a mass basis. In addition, unless otherwise particularly noted, the evaluation was performed in an environment at a temperature of 25.0° C. and a relative humidity of 40.0%.

### 3.1. Preparation of Each Ink

After being charged in a container in order to obtain the compositions shown in Tables 1 and 2, the individual components were mixed and stirred for 2 hours by a magnetic stirrer, so that sufficient mixing was performed. After stirring was further performed for one hour, filtration was performed using a 5.0-μm PTFE-made membrane filter, so that a color ink (B1) and clear inks (CL1 to CL16) were obtained. As water, pure water was used.

The components shown in Tables 1 and 2 are as described below. The pigment, the fixing resin, and the wax are each on a solid content basis.

### Resin Dispersion Pigment

After 10 parts by mass of an ammonium salt of a styrene-acrylic acid copolymer (weight average molecular weight: 10,000) which was used as a polymer component functioning as a dispersant and 55 parts by mass of ion exchange water were added to 15 parts by mass of carbon black and then sufficiently stirred, the mixture thus obtained was dispersed for 2 hours with glass beads (diameter: 1.7 mm, 1.5 times the volume of the solid content of the mixture) in a sand mill (manufactured by Yasukawa Seisakusho Co., Ltd.). After the mixture was dispersed, the glass beads were removed, so that a resin dispersion pigment liquid was obtained and used.
Joncryl 631: manufactured by BASF, styrene-acrylic-based resin emulsion
Superflex 210: manufactured by DKS Co., Ltd., urethane-based resin emulsion
Hitech E7100S: manufactured by Toho Chemical Industry Co., Ltd., polyethylene wax
Hitech E6314: manufactured by Toho Chemical Industry Co., Ltd., polyethylene wax
AQUACER 539: manufactured by BYK Japan KK, paraffin wax
AQUACER 515: manufactured by BYK Japan KK, polyethylene wax
BYK-348: manufactured by BYK Japan KK, silicone-based surfactant
BYK-333: manufactured by BYK Japan KK, silicone-based surfactant
DF110D: manufactured by Air Products Japan, K.K., acetylene glycol-based surfactant

In addition, the particle diameter of the wax was measured in a manner such that after a product used here was diluted 400 times, the measurement was performed using a nanoparticle size analyzer NANOTRAC WAVE II manufactured by Microtrac, and the results are shown in the tables.

### 3.2. Evaluation Method

### 3.2.1. Recording Test

An SC-S80650 (manufactured by Seiko Epson Corporation) modified machine was prepared. A nozzle density of a nozzle line of a head was 360 dpi. A platen heater and an air blowing fan were provided, and a wind velocity of the fan was set to 5 m/s. A wind temperature was set to 25° C. A primary heating temperature (surface temperature of the recording medium) during composition adhesion was set to that shown in Tables 3 to 5. By a secondary heater located downstream, a secondary heating was performed at a surface temperature of 70° C. of the recording medium.

As for the ejection order of the color ink and the clear ink, “simultaneous” indicates the simultaneous adhesion of the above second adhesion mode, and “color first” indicates the order of the above first adhesion mode.

As for a clear ink application area of the non-image portion, “entire” indicates application performed over the entire surface of the non-image portion in a recordable region of the recording medium, and “partial” indicates application performed in an area having a width of 5 cm from the edge of the entire periphery of the image portion.

As the recording medium, a recording medium having a shape of 30 cm×60 cm was used. At the center of the recording medium, a solid-pattern image portion having a shape of 5 cm×10 cm was printed so that a long side thereof was along the longitudinal side of the recording medium.

The application amount of the clear ink in the non-image portion was set as shown in the table. In the example in which the clear ink was applied to the image portion, the clear ink was applied over the entire image portion, and the application amount thereof was set as shown in the table.

The recording was performed such that the recording resolution in the printing was set to 1,440×720 dpi, and the adhesion amount of the color ink to the image portion was set to 7 mg/inch². Unless otherwise particularly noted, the pass number was set to 8. The clear ink was applied by the same recording method as that for the color ink. The adhesion amount was adjusted by a dot density.

### 3.2.2. Evaluation Substrate

As the evaluation substrates (printing substrates) of Examples, the following substrates were used and are shown in Tables 3 to 5.
Y-1: YUPO (UV) PAT1 9K, manufactured by Lintec Corporation, substrate with in-plane surface roughness (Sa)=0.7 μm
Y-2: Super YUPO FRRG, manufactured by Lintec Corporation, substrate with in-plane surface roughness (Sa)=0.4 μm
Y-3: New YUPO FGS #130, manufactured by Lintec Corporation, substrate with in-plane surface roughness (Sa)=1.0 μm
P: PET50A, manufactured by Lintec Corporation, substrate with in-plane surface roughness (Sa)=0.07 μm

In addition, as a surface roughness measurement apparatus, a laser microscope VK-X1000 was used, and the in-plane surface roughness (Sa) was measured by using a 20 times object lens.

### 3.2.3. Evaluation of Drying Property

The printing was performed by 8-pass or 6-pass printing conditions. The color ink and the clear ink were each printed by the above pass number. After the printing, a printed matter was obtained by cutting and then rubbed to and fro between the image portion and the non-image portion 10 times using BEMCOT, and stains of the image portion and the BEMCOT were observed. The rubbing was performed along a longitudinal direction of the image portion. The evaluation was performed in accordance with the following criteria, and the results are shown in the tables.
A: color transfer to BEMCOT and stain of image portion are not observed by 6 passes.
B: color transfer to BEMCOT and stain of image portion are not observed by 8 passes.
C: color transfer to BEMCOT and stain of image portion are observed by 8 passes.

In addition, since BEMCOT is not synthetic paper (such as YUPO), it is assumed that no abrasion may occur by fine particles contained in synthetic paper. When the clear ink in the non-image portion is not sufficiently dried, the clear ink is transferred from the non-image portion to the image portion, and the image portion may be prevented from being dried in some cases.

### 3.2.4. Evaluation of Abrasion Resistance

The abrasion resistance (scumming of the non-image portion) of each Example was evaluated. By using a Gakushin type rubbing fastness tester (AB-301S, manufactured by Tester Sangyo Co., Ltd.), the image portion of the recorded matter obtained as described above was rubbed 30 times in a longitudinal direction by friction paper at a load of 500 g. As the friction paper, the same substrate as that used for the recording was used. In the case in which the clear ink was used, the clear ink of each Example was applied to the entire surface of the substrate at an amount of 1 mg/inch², and this substrate was used as the friction paper. In the case in which the clear ink was not applied to the non-image portion (Comparative Examples 4 and 5 and Reference Example), friction paper to which the clear ink was not applied was used for evaluation. In addition, when the rubbing was performed, the friction paper was reciprocally moved across the image portion. That is, from one end to the other end of the recording region of the recorded matter, the rubbing was performed across the image portion in the longitudinal direction.

The evaluation was performed in accordance with the following criteria, and the results are shown in the tables.
A: No scumming of non-image portion is observed.
B: Slight scumming of non-image portion is observed but is not conspicuous.
C: Scumming of non-image portion is observed but is not observed in an area having a width of 1 cm or more from the edge of the periphery of the image portion.
D: Scumming of non-image portion is conspicuous and is also observed in an area having a width of 1 cm or more from the edge of the periphery of the image portion.

### 3.2.5. Evaluation of Abrasion Resistance (Ink Transfer)

The same recorded matter as that used for the evaluation of the abrasion resistance was formed, and the same test as described above was performed. The evaluation was performed in accordance with the following criteria, and the results are shown in the tables.
A: Color transfer to friction paper is hardly observed.
B: Color transfer to friction paper is very slightly observed but is not conspicuous.
C: Color transfer to friction paper is slightly observed.
D: Color transfer to friction paper is apparently observed.

### 3.2.6. Evaluation of Bleeding

A lattice patter having a width of 1 cm, the pattern shape of which was different from that used in the above evaluation, was printed using the color ink. Portions other than the lattice pattern of the color ink were regarded as the non-image portion, and the clear ink was adhered thereto. The bleeding of the color ink and the clear ink at the boundary between the image portion and the non-image portion was confirmed by visual inspection. In addition, in this evaluation, since the image portion of the color ink was the lattice pattern having a width of 1 cm, in some Example (Example 16), the clear ink application area of the non-image portion was the same as that obtained when the clear ink was applied to the entire surface. The evaluation was performed in accordance with the following criteria, and the results are shown in the tables.
A: No bleeding is observed.
B: Bleeding is observed when viewed at close range.
C: Bleeding is observed but is not conspicuous.
D: Bleeding is conspicuous.

### 3.2.7. Evaluation of Clogging Recovery Property

Recording was performed for 2 hours under the recording conditions described above. However, after the recording was performed, simulated recording to eject no ink from the head was performed. After the recording was performed, non-ejection nozzles were recovered by suction cleaning, and nozzle tests were performed. By one cleaning, 1 cc of the ink was discharged from the nozzle line. Evaluation was performed in accordance with the following criteria, and the results are shown in tables. This evaluation was performed for the clear ink.
A: By one cleaning, all nozzles are recovered.
B: By three cleanings, all nozzles are recovered.
C: By six cleanings, all nozzles are recovered.
D: By six cleanings, some nozzles are not recovered.

### 3.3. Evaluation Results

The evaluation results are shown in Tables 3 to 5. From the tables, it is found that in the recording method of each Example in which the recording medium is a non-absorbing or a low-absorbing recording medium including a substrate with an in-plane surface roughness (Sa) of 0.2 μm or more, the clear ink composition contains the resin and the wax and contains no polyol having a standard boiling point of 280° C. or more functioning as an organic solvent at a content of 0.5 percent by mass or more with respect to the total mass of the clear ink composition, and the clear ink composition is adhered to the non-image portion which is a region other than the image portion which is a region of the recording medium to which the color ink composition is adhered, the abrasion resistance (stain of the non-image portion) of a recorded matter to be obtained is preferable.

The present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

From the embodiments and modified examples described above, the following conclusions are obtained.

A recording method of the present disclosure comprises: an ink adhesion step of ejecting a water-based color ink composition containing a colorant from an ink jet head so as to be adhered to a recording medium; and a clear ink adhesion step of ejecting a water-based clear ink composition from the ink jet head so as to be adhered to the recording medium. In the recording method described above, the recording medium is a non-absorbing or a low-absorbing recording medium having a surface with an in-plane surface roughness (Sa) of 0.2 μm or more, the clear ink composition contains a resin and a wax and contains no polyol having a standard boiling point of 280° C. or more functioning as an organic solvent at a content of 0.5 percent by mass or more with respect to a total mass of the clear ink composition, and the clear ink composition is adhered to a non-image portion which is a region other than an image portion which is a region of the recording medium to which the color ink composition is adhered.

According to this recording method, even when a non-absorbing or a low-absorbing recording medium including a substrate with an in-plane surface roughness (Sa) of 0.2 μm or more is used, a recorded matter that can suppress the color transfer of the color ink composition to the non-image portion can be obtained.

The reason this effect is obtained is believed that since the non-image portion is planarized by the resin contained in the clear ink composition and is also made slippery by the wax, even when the non-image portion is rubbed by the image portion, the component of the color ink composition is not likely to be transferred.

In addition, according to this recording method, since the polyol having a standard boiling point of 280° C. or more functioning as an organic solvent is not contained in the clear ink composition at a content of 0.5 percent by mass or more with respect to the total mass thereof, the drying property of the clear ink composition after the adhesion to the recording medium is preferable, and the effect described above can be more rapidly obtained.

In the recording method described above, a total content of the resin and the wax contained in the clear ink composition may be 4 to 10 percent by mass with respect to the total mass of the clear ink composition.

According to this recording method, the color transfer of the color ink composition to the non-image portion can be further suppressed.

In the recording method described above, a mass ratio (wax/resin) of the resin and the wax contained in the clear ink composition may be 0.25 or more.

According to this recording method, the color transfer of the color ink composition to the non-image portion can be further suppressed.

In the recording method described above, the wax may be a polyolefin wax having a melting point of 120° C. or more.

According to this recording method, the color transfer of the color ink composition to the non-image portion can be further suppressed.

In the recording method described above, the wax may have a volume average particle diameter (D50) of 50 nm or more.

According to this recording method, the surface irregularity of the recording medium is more easily planarized, and the color transfer of the color ink composition to the non-image portion can be further suppressed.

In the recording method described above, a difference in surface tension between the color ink composition and the clear ink composition may be 2 mN/m or less.

According to this recording method, the color transfer of the color ink composition to the non-image portion can be further suppressed.

In the recording method described above, a total adhesion amount of the resin and the wax contained in the clear ink composition in the non-image portion may be 0.4 mg/inch² or less.

According to this recording method, the color transfer of the color ink composition to the non-image portion can be further suppressed.

In the recording method described above, a region of the non-image portion to which the clear ink composition is adhered may include an area having a width of 2 cm or more from the edge of the periphery of the image portion.

According to this recording method, even when the region of the non-image portion to which the clear ink composition is adhered is not the entire region of the non-image portion, the color transfer of the color ink composition to the non-image portion can be suppressed.

In the recording method described above, an adhesion amount of the clear ink composition to the image portion adjacent to the non-image portion to which the clear ink composition is adhered may be equal to or less than an adhesion amount of the clear ink composition to the non-image portion.

According to this recording method, the color transfer of the color ink composition to the non-image portion can be further suppressed. In addition, in this recording method, it is assumed such that the adhesion of the clear ink composition to the image portion is effective but is not always necessary. That is, the assumption described above is considered based on the fact that since the surface of the recording medium is irregular, when the image portion is rubbed, although the color ink composition is transferred, peeling of the ink of the image portion is not made conspicuous by this transfer, and the stain of the non-image portion is conspicuous. On the other hand, it is also assumed that when the clear ink composition is adhered to the image portion, depending on the adhesion amount thereof, the total adhesion amount to the image portion is increased, and as a result, the bleeding is generated in the image portion.

A recording apparatus of the present disclosure is a recording apparatus to perform one of the recording methods described above and comprises the above color ink composition, the above clear ink composition, and an ink jet head to eject the color ink composition and the clear ink composition.

According to this recording apparatus, even when a non-absorbing or a low-absorbing recording medium including a substrate with an in-plane surface roughness (Sa) of 0.2 μm or more is used, a recorded matter that can suppress the color transfer of the color ink composition to the non-image portion can be obtained.

What is claimed is:

1. A recording method comprising:
an ink adhesion step of ejecting a water-based color ink composition containing a colorant from an ink jet head so as to be adhered to a recording medium; and
a clear ink adhesion step of ejecting a water-based clear ink composition from the ink jet head so as to be adhered to the recording medium,
wherein the recording medium is a non-absorbing or a low-absorbing recording medium having a surface with an in-plane surface roughness Sa of 0.2 μm or more,
the clear ink composition contains a resin and a wax and contains no polyol having a standard boiling point of 280° C. or more functioning as an organic solvent at a content of 0.5 percent by mass or more with respect to a total mass of the clear ink composition, and
the clear ink composition is adhered to a non-image portion which is a region other than an image portion which is a region of the recording medium to which the color ink composition is adhered.

2. The recording method according to claim 1,
wherein a total content of the resin and the wax contained in the clear ink composition is 4 to 10 percent by mass with respect to the total mass of the clear ink composition.

3. The recording method according to claim 1,
wherein a mass ratio (wax/resin) of the resin and the wax contained in the clear ink composition is 0.25 or more.

4. The recording method according to claim 1,
wherein the wax is a polyolefin wax having a melting point of 120° C. or more.

5. The recording method according to claim 1,
wherein the wax has a volume average particle diameter D50 of 50 nm or more.

6. The recording method according to claim 1,
wherein a difference in surface tension between the color ink composition and the clear ink composition is 2 mN/m or less.

7. The recording method according to claim 1,
wherein a total adhesion amount of the resin and the wax contained in the clear ink composition in the non-image portion is 0.4 mg/inch² or less.

8. The recording method according to claim 1,
wherein a region of the non-image portion to which the clear ink composition is adhered includes an area having a width of 2 cm or more from the edge of the periphery of the image portion.

9. The recording method according to claim 1,
wherein an adhesion amount of the clear ink composition to the image portion adjacent to the non-image portion to which the clear ink composition is adhered is equal to or less than an adhesion amount of the clear ink composition to the non-image portion.

10. A recording apparatus which performs the recording method according to claim 1, the apparatus comprising:
the color ink composition;
the clear ink composition; and
an ink jet head to eject the color ink composition and the clear ink composition.
